(19) United States
(12) Patent Application Publication
(10) Pub. No.: US 2007/0063459 A1
(43) Pub. Date: Mar. 22, 2007

(54) Interface system for retaining a foot or a boot on a sports article

(76) Inventor: Raymond R. Kavarsky, BOZEMAN, MT (US)

Correspondence Address: Raymond R. Kavarsky, 1502 Farmington Ave., Berlin, CT, 06037, US

(21) Appl. No.: 10/515,242

(22) PCT Filed: May 16, 2003
(86) PCT No.: PCT/US03/15671

§ 371 Date: Nov. 18, 2004

Related U.S. Application Data
(60) Provisional application No. 60/382,929, filed on May 21, 2002.

(51) Int. Cl. B62B 13/00

(52) U.S. Cl. 280/14.23

(57) ABSTRACT

An interface system (1) comprising one or more linkage member(s) (30, 48, 49, 51, 52, 61) that have the purpose of retaining an individual's foot/ankle (either bare or covered) on a sports article. The system (1) comprises a rigid base structure (4) a having lateral edge (7) and medial edge (10), and heel loop portion (73); one or more pliable linkage members (30, 48, 49, 51, 52, 61) that wrap around the user's foot/ankle or boot and are tensionably adjustable and disconnectable.

### CROSS-REFERENCE TO RELATED APPLICATIONS

This application claims the benefit of U.S. Provisional Application No. 60/382929, filed May 21, 2002, the disclosure of which application is incorporated by reference as if fully set forth herein.

### STATEMENT REGARDING FEDERALLY SPONSORED RESEARCH OR DEVELOPMENT

Not Applicable

### TECHNICAL FIELD

This invention relates to an interface system for retaining a foot or a boot on a sports article. In particular, the invention relates to an interface system for retaining a human foot/ankle (either bare or covered) on a snowboard, snowshoe, wakeboard, inline skate or other sports article. The system may also be used as an internal or external support structure for a boot or other footwear. Although the field of application of the invention is broad, its preferred application is as a snowboard interface system. Consequently, this disclosure addresses that application.

### BACKGROUND ART

Current snowboard binding designs consist mainly of two separate technologies: traditional strap-style bindings and step-in-style bindings. Strap bindings have been available for a longer time and comprise the majority of the binding market. They traditionally consist of a rigid base,.heel loop and high-back structure along with flexible, padded ankle and toe straps. Although many improvements have been made over the past years to increase the performance, durability, and comfort levels of strap bindings, the archaic concept of a two-strap system connected to a rigid base, with the effect of binding a rider's foot to the board, remains fundamentally unchanged.

During the mid 1990's, the step-in snowboard binding was introduced. The primary focus of the step in design is ease of use and speed of entry/exit. Although the step-in binding has been very popular (mainly with the rental and beginner market), it has never been able to offer the comfort and performance of a strap binding.

The background art is characterized by U.S. Pat. Nos. 4,271,609; 4,793,075; 5,261,689; 5,401,041; 5,556,123; 5,918,387; 5,918,897; 5,967,531; 5,970,632; 5,971,419; 5,992,861; 6,065,770; 6,185;846; 6,206,403; 6,283,492 and 6,293,566 and U.S. Patent Application Publication No. US 2001/0009320 A1; the disclosures of which patents and application are incorporated by reference as if fully set forth herein.

Marrifield in U.S. Pat. No. 4,271,609 discloses a snowshoe. This invention is limited in that the binding relies on a toe strap and only one disconnectable buckle is provided. Moreover, no means are provided to secure the user's heel to the snowshoe to allow the user's toe to dip downward into the snow.

Thatcher in U.S. Pat. No. 4,793,075 discloses a sport sandal. This invention is limited in that the binding relies on a toe strap and lateral strap that does not cross over the foot. This invention is limited in that the binding relies on a toe strap and two crossover straps that begin and end on the same edges.

Carpenter et al in U.S. Pat. No. 5,261,689 disclose a snowboard boot binding system. This invention is limited because, while holds are provided in the edges of the base, no disclosure is made of appropriate means for holding a boot in the binding.

Jespersen in U.S. Pat. No. 5,401,041 discloses a boot binding system for a snowboard. This invention is limited in that it relies on a toe strap and a rigid heel binding.

Fournier in U.S. Pat. No. 5,556,123 discloses a snowboard binding with a compensating plate. This invention is limited in that the pair of cables that secure the boot to the snowboard are tightened by means of a fastener that is attached to the vertical support member.

Emerson in U.S. Pat. No. 5,918.387 discloses a snowshoe harness. This invention is limited in that one embodiment relies on a single combination toe/instep strap having a Z configuration and a heel strap. Another embodiment relies on two straps that connect in the middle but not directly on top of the user's foot. Yet another embodiment relies on a toe strap plus a single cross strap.

Hansen et al. in U.S. Pat. No. 5,918,897 disclose a snowboard binding. This invention is limited in that it relies on two cross straps that are buckled on the same side and a pivotable heel element that is secured in place by a heel strap.

Saillet in U.S. Pat. No. 5,967,531 discloses a device for retaining a boot on a board. Thus invention is limited in that it relies on a toe strap and an instep strap. The toe strap buckles to the base and the instep strap buckles to the vertical support member on the same side.

Watson in U.S. Pat. No. 5,970,632 discloses a snowshoe with an adjustable binding. This invention is limited in that a combination toe/instep strap and a heel strap are provided. Moreover, the instep strap crosses the toe once and the instep four times before a buckle is provided.

Knapschafer in U.S. Pat. No. 5,971,419 discloses a rotational binding for a freestyle snowboard. This invention is limited in that it is designed to accommodate a hard-shelled boot Moreover, the adjustment bumpers are disposed vertically.

Hansen et al. in U.S. Pat. No. 6,065,770 disclose a snowboard binding. In one embodiment, the invention is limited in that four tensile elements and a cross strap are provided. In another, a resilient belt and two toothed belts are provided.

Neidhardt, Jr. in U.S. Pat. No. 6,185,846B1 discloses a maneuverable snowshoe. This invention is limited in that it relies on a toe strap, an instep strap and a heel strap that buckle on the same side.

Black et al. in U.S. Pat. No. 6,206,403 B1 discloses a snowboard strap binding. The invention is limited in that it relies on a toe strap and an ankle strap that buckle on the same side. A heel strap is also provided to which the ends of the ankle strap are attached.

Hale in U.S. Pat. No. 6,283,492 B1 discloses a snowboard binding system. This invention is limited in that it relies on straps or other means to support the vertical support member.

Carpenter et al. in U.S. Pat. No. 6,292,566 B1 disclose a unitary strap for use in a soft boot snowboard binding. This invention is limited in that a toe strap and buckle are required. Moreover, the ankle strap is connected to the toe strap.

Couderc et al. in U.S. Patent Application Publication US 2001/0009320 A1 disclose a device for retaining a boot on a sports article. This invention is Limited in that only a single ankle strap is provided.

Traditionally, strap binding designs attempt to increase comfort by increasing the thickness of the padding between the binding strap and the users foot, and/or having a more anatomical shape and larger surface area for the straps and pads. The problem with increasing the thickness of the padding is that it results in more movement of the foot within the constraints of the binding (because of the compression of the padding) this also results in more, undesirable, heel lift The technique of providing a more anatomically-shaped system along with more surface area does, however, increase comfort levels, and is a common practice in any art dealing in an interface with the human body.

One company, Flow, has taken the increase in surface area technique to the extreme of having one single mostly homogenous strap (or pad) that covers most of the front/top of the user's foot While this system does reduce the required tension of the strap, it is not locally conformable due to the complex shape of the foot The main focus of the Flow system is entry/exit convenience by means of a rear-entry type system.

Increasing the ease of use and entry/exit speed of traditional strap bindings has been attempted by reducing the number of entry/exit mechanisms (or ladder ratchets) from two to one. This technique is approached in the Salomon application (No. 2001/0009320 A1) and in the Burton patent (U.S. Pat. No. 6,293,566) which are primarily focused on simplifying ease of use and not on increasing performance and comfort of the system.

Solving the problem of heel-lift has been approached in many ways. For the most part, current strap bindings address the problem by incorporating a deeper and better-shaped heel pocket into the design of the high back, as well as adhering a layer of rubber or soft material to the inside of the high back so as to grip the outer surface of the boot more effectively. Riders usually further decrease heel-lift by tightening down the ankle strap as much as they can stand. What is lacking in background art designs is a heel linkage segment that is designed to dramatically reduce heel-lift and required strap tension by applying increasing downward force to the backside of the rider's boot as well as holding the gripping surface of the high back against the back of the boot, as tension in the linkage members is increased. The background art is also lacking a dynamically conformable retention system capable of being adapted (or adjusted) to the user's specific ankle axis geometry.

The Nike patent (U.S. Pat. No. 6,206,403 B1) is the only other system known to the applicant that incorporates any type of tensioning member to the back of the riders boot However, this system also uses a traditional ankle strap, which is referred to as a secondary strap because it is connected (at both extents) to each side of the heel-tensioning member (or heel strap.) The applicant believes that this connection method does not provide adequate tension of the heel strap in the proper direction, nor does it provide sufficient resistance to the keep the boot pulled back towards the vertical support member and therefore, is not as effective as the configuration of the present invention.

Traditionally, snowboard bindings have different levels of lateral and medial flex in order to accommodate different riding styles and conditions. This is presently accomplished by altering the geometry and thickness of the components or by the use of different rigidity of material in the base, heel loop, and vertical support members, e.g., using a thirty percent glass filled polymer instead of twenty percent glass filled polymer to achieve a less flexible component This method however does not offer the user any means of adapting the system to their preferred levels of flex. The user presently must purchase different products in order to obtain different levels of lateral/medial flex from the base structure and high back.

Therefore, what is needed is a means of adjusting the lateral and/or medial flex behavior of the vertical support member and or heel loop portion of the base structure. This type of adjustment is not known to be offered in any existing snowboard binding and provides the ability to adapt a single product to a variety of riding styles and terrain. Presently, snowboard bindings are manufactured with varying flex patterns of the base and vertical support member. This causes the need for different materials and sometimes different molds in order to offer a diverse product line. What is needed are means to reduce that need by allowing one product to be adapted to various riding styles and terrains and to be used on any other system as well

What is also needed is the incorporation of a tool for adjusting the various fasteners of an interface system. This tool would preferably be mounted to the outside surface of the vertical support member and would preferably be incorporated into any other binding system as well. The addition of a multi tool mounted to the vertical support member would be of benefit to the user needing an on-the-spot adjustment. Also it would eliminate the dangerous need to carry a tool on the person while in activity.

### DISCLOSURE OF THE INVENTION

The present invention is a strap-style snowboard binding designed to be compatible with any “soft” snowboard boot During development of the system, the main focus was on rider comfort 30 and interface performance. Studies of foot and ankle biomechanics during snowboarding were also influential in the development of the system.

The purpose of the preferred embodiments of the invention is to provide a no-compromise, high-performance snowboard-rider interface system, utilizing innovative design and quality construction Preferred embodiments of the invention provide a level of comfort and performance unprecedented in the snowboard industry. The benefits obtained allow snowboarders to ride longer, more comfortable days. The system provides a more natural and responsive interface with the board, thereby enhancing the riding experience and providing the ability for more technical and advanced maneuvers.

Enhancements in comfort and performance derive primarily from the preferred lace wrap retention system, which replaces conventional toe and ankle straps with single- or multi-piece lateral and medial linkage members providing more surface contact area than traditional toe and ankle straps. A heel segment is also incorporated into other preferred embodiments. The configuration of the linkage members provides a dynamic “web” of retention that is able to conform to the complex shape of the human foot better than any other strap binding technology. Using only very thin or non-existent padding layers, the lace wrap retention system inherits elements of its performance traits from the traditional and proven method of a crisscross shoelace system.

A more preferred embodiment of the invention incorporates means for adjusting the position of relevant tension members to be anatomically corrected to the user's individual ankle axis geometry. A basic version of the lace wrap retention system is disclosed as a preferred embodiment of the invention. The linkage members described in this embodiment constitute the basic elements of the invention, even though their routing and connection methods may vary in alternate embodiments.

The lace wrap retention system is intended to replace conventional toe and ankle straps with a single- or multi-piece wrap device, providing more surface area than conventional straps. Therefore, the system requires less tension to achieve the same level of security and control, resulting in increased comfort and performance for the rider. Certain embodiments of the lace wrap also provide resistance against the problem of heel lift by incorporating a linkage, which provides retention to the back side of the rider's heel. Because the lace wrap is preferably constructed of a thin pliable material and is configured in a crisscross manner (similar to a shoe lace), it is far more able to conform locally to the shape of the user's foot than a conventional two-strap system. Providing a dynamic web of retention that is responsive in all directions, this last trait provides a more genuine “interface” between the board and rider.

Preferred embodiments of the present invention also offer the user the ability to adjust the lateral/medial flex of the heel loop and/or vertical support member (high back) by the means disclosed herein. This eliminates the need to manufacture multiple product models and offers custom tailored performance to a multitude of riding styles and conditions, in one product model. This is accomplished by positioning a bumper component on either side of the heel loop portion of the base structure or the vertical support member. This bumper component is positioned so as to interfere with, and thus limit the flex of the heel loop or vertical support member when either of those components is flexed in the lateral or medial direction during various snowboarding maneuvers. Preferably, the bumper component is adjustably mounted on a rigid support member. The support member may be mounted on the base structure or alternatively, be part of the base structure. This rigid support member is preferably located in the general area of the side of the heel loop portion of the base structure approximately following the profile of the heel loop surface and being substantially widened away from the base structure. The support member has an inside surface which is angled away from the heel loop portion so as to allow unrestricted flex of the heel loop and vertical support member.

Preferably, the bumper component is mounted so as to protrude past this surface, towards the outer surface of the heel loop or vertical support member, at a distance which is adjustable, and, therefore, allows different limits on the flex of the heel loop and/or vertical support member. It is further preferred that the bumper component be mounted in a slot of the rigid support member so that it may be positioned to interfere with different locations on the outside surface of the heel loop portion of the base structure or the vertical support member. This allows even greater customization of the flex patterns and limits of motion of the heel loop and/or vertical support member.

In one preferred embodiment (in which the heel loop and base structure are one piece), the bumper support member is mounted to, or part of the base structure and the bumper interferes with the outside surface of the vertical support member. In another preferred embodiment (in which the heel loop and base plate are separate pieces), the bumper support member is mounted to or part of the base structure and the bumper interferes with the outside surface of the heel loop, or with the outside surface of the vertical support member, through an opening in the heel loop.

Another aspect of preferred embodiments of the invention is the addition of a tool used for adjusting the various fasteners of the system. This tool is preferably mounted on the outside surface of the vertical support member and may be incorporated into other binding systems as well. The addition of a multi tool mounted to the vertical support member is of benefit to the user needing on-the-spot adjustment It also eliminates the need for a user to carry a tool on his/her person while performing a sports activity, which can be dangerous.

In a preferred embodiment, the invention is an interface system for retaining a foot or a boot of a user on a sports article, the interface system comprising: a base structure consisting of a first (e.g., lateral) edge having a first front portion and a first back portion and a second (e.g., medial) edge having a second front portion and a second back portion, and a heel loop portion that is adjustably connected to said first back portion and to said second back portion or is a contiguous portion of said first edge and said second edge; a vertical support member that is attached to the heel loop portion; a first ankle coupling member that is coupled to the heel loop portion or to the vertical support member and is oriented upwards slightly towards the proximal end of the user's leg; a second ankle coupling member that is coupled to the heel loop portion or to the vertical support member and is oriented upwards slightly towards the proximal end of the user's leg; a first disconnectable coupling member that is coupled to the second back portion; a second disconnectable coupling member that is coupled to the first back portion; a first linking member comprising: a first end that is connected to the first ankle coupling member, a first ankle crossover linkage segment that extends between the first ankle coupling member and the first disconnectable coupling member, and a first toe crossover linkage segment that extends between the first disconnectable coupling member and a second end that is coupled to the first front portion, said ends and segments being contiguous in the order described; a second linking member comprising: a first terminus that is coupled to the second ankle coupling member, a second ankle crossover linkage segment that extends between the second ankle coupling member and the second disconnectable coupling member, and a second toe crossover linkage segment that extends between the second disconnectable coupling member and a second terminus that is coupled to the second front portion, said termini and segments being contiguous in the order described; and a heel linkage member that extends between the first ankle coupling member and the second ankle coupling member. Preferably, the interface system further comprises a first primary ankle anchor member by which the first ankle coupling member is coupled to the heel loop or the vertical support member and a second primary ankle anchor member by which the second ankle coupling member is coupled to the heel loop or the vertical support member. Preferably, the first ankle coupling member is also coupled to the first back portion and the second ankle coupling member is also coupled to the second back portion. Preferably, the first ankle crossover linkage segment is fastened to the first ankle coupling member, the second ankle crossover linkage segment is fastened to the second ankle coupling member and heel linkage member is fastened to the first ankle coupling member and the second ankle coupling member. Preferably, the first ankle crossover linkage segment passes through the first ankle coupling member and the second ankle crossover linkage segment passes through the second ankle coupling member and the first ankle crossover linkage segment is connected to the second ankle crossover linkage segment by the heel linkage member.

In another preferred embodiment, the invention is a device for retaining a boot on a sports article, the device comprising: a rear positioning element adapted to receive a rear of an upper of the boot (e.g., a vertical support member), two edges, and a plurality of linkages extending between the edges; a first of said plurality of linkages having two or more points of fastening to a first of the two edges and a single point of fastening to a second of the two edges; a second of said plurality of linkages having two or more points of fastening to the second of the two edges and a single point of fastening to the first of the two edges; and a third of said plurality of linkages that connects to and extends between said first of said plurality of linkages and said second of said plurality of linkages.

In a further preferred embodiment, the invention is an interface system for retaining a foot or a boot on a sports article, the interface system comprising: a base structure having a first (e.g., lateral) edge, a second (e.g., medial) edge, and a heel loop connected to the first edge and the second edge; a first linking member having two ends and a middle, one of the ends being fastened to the heel loop or to the first edge, the other of the ends being fastened to the first edge and the middle being releasably connected to the second edge; a second linking member having two endings and a center, one of the endings being fastened to the heel loop or to the second edge, the other of the endings being fastened to the second edge and the center being releasably connected to the first edge; and a third linking member that connects said first lining member to said second linking member. Preferably, the one of the ends is fastened to the heel loop or to the first edge via a first ankle coupling member and the one of the endings is fastened to the heel loop or to the first edge via a second ankle coupling member. Preferably, the interface system further comprises a vertical support member that is attached to the heel loop and the vertical support member comprises a first layer and a second layer, the first layer being pliable and the second layer being rigid or semi-rigid and having a cutout adjacent its bottom. Preferably, the interface system further comprises a first connector coupled or attached to said center and a second connector coupled or attached to said middle.

In a further preferred embodiment, the invention is an interface system for retaining a foot or a boot of a user on a sports article, the interface system comprising: a base structure consisting of a first edge having a first back portion and a first front portion and a second edge having a second back portion and a second front portion, and a heel loop portion that is either adjustably connected to said first edge and to said second edge, or is integral with said first edge and said second edge; a vertical support member that is attached to the heel loop portion; a first ankle coupling member that is coupled to the heel loop portion of the base structure or to the vertical support, a second ankle coupling member that is coupled to the heel loop portion of the base structure or to the vertical support; a first disconnectable coupling member that is coupled to the second back portion; a second disconnectable coupling member that is coupled to the first back portion; a first linking member comprising: a first end that is connected to the first ankle coupling member, a first ankle crossover linkage segment that extends between the first ankle coupling member and the first disconnectable coupling member, and a second end that is connected to the first disconnectable coupling member, said ends and segments being contiguous in the order described; a second linking member comprising a first terminus that is coupled to the second ankle coupling member, and a second ankle crossover linkage segment that extends between the second ankle coupling member and a second terminus that is coupled to the second disconnectable coupling member, and a second terminus that is connected to the second disconnectable coupling member, said termini and segments being contiguous in the order described; and a heel linkage member that extends between the first ankle coupling member and the second ankle coupling member. Preferably, the interface system further comprises a first primary ankle anchor member by which the first ankle coupling member is coupled to the heel loop or the vertical support member and a second primary ankle anchor member by which the second ankle coupling member is coupled to the heel loop or the vertical support member. Preferably, the first ankle coupling member is also coupled to the first back portion and the second ankle coupling member is also coupled to the second back portion. Preferably the first ankle crossover linkage segment is connected to the first ankle coupling member and the second ankle crossover linkage segment is connected to the second ankle coupling member. Preferably, the first ankle crossover linkage segment passes through the first ankle coupling member and the second ankle crossover linkage segment passes through the second ankle coupling member and the first ankle crossover linkage segment is connected to the second ankle crossover linkage segment by the heel linkage member.

In another preferred embodiment, the invention is a device for retaining a boot on a sports article, the device comprising: a rear positioning element adapted to receive a rear of an upper of the boot (e.g., a vertical support member), two edges, and a plurality of linkages extending between the lateral edges;

a first of said plurality of linkages having two or more points of fastening to a first of the two edges and a single point of fastening to a second of the two edges; a second of said plurality of linkages having a single point of fastening to the second of the two edges and a single point of fastening to the first of the two edges; and a third of said plurality of linkages that connects to and extends between said first of said plurality of linkages and said second of said plurality of linkages.

In yet another preferred embodiment, the invention is an interface system for retaining a foot or a boot on a sports article, the interface system comprising: a base structure having a first (e.g., medial) edge, a second (e.g., lateral) edge, and a heel loop connected to the first edge and to the second edge; a first linking member having two ends and a middle, one of the ends being fastened to the heel loop or to the first edge, the other of the ends being fastened to the first edge and the middle being releasably connected to the second edge; a second linking member having two endings, one of the endings being fastened to the heel loop or to the second edge, the other of the endings being releasably connected to the first edge; and a third linking member that connects said one of the ends to said one of the endings. Preferably, the one of the ends is fastened to the heel loop or to the first edge via a first ankle coupling member and the one of the endings is fastened to the heel loop or to the first edge via a second ankle coupling member. Preferably, the interface system further comprises a vertical support member that is attached to the heel loop; wherein the vertical support member comprises a first layer and a second layer, the first layer being pliable and the second layer being rigid or semi-rigid and having a cutout adjacent its bottom. Preferably, the interface system further comprising: a first connector attached (e.g., bolted or riveted) to said middle and a second connector attached (e.g., bolted or riveted) to the other of the endings.

In yet another preferred embodiment, an interface system for retaining a foot or a boot of a user on a sports article, the interface system comprising: a base structure consisting of a first (e.g., lateral) edge having a first heel portion, a first middle portion and a first toe portion and a second (e.g., medial) edge having a second heel portion, a second middle portion and a second toe portion, and a heel loop portion that is either adjustably connected to said first edge and to said second edge (as is the case with many traditional binding systems), or is a contiguous portion of said first edge and said second edge; a vertical support member that is attached to the heel loop portion of the base structure; a first ankle coupling member that is coupled to the heel loop portion of the base structure or to the vertical support member and oriented upwards slightly towards the proximal end of the user's leg; a second ankle coupling member that is coupled to the heel loop portion of the base structure or to the vertical support member and oriented upwards slightly towards the proximal end of the user's leg; a single linking member having a first end that is attached to the second toe portion, a first toe cross over linking segment that is releasably connected to the first middle portion, a second ankle cross over segment that is fastened to the second anchor coupling member, a heel linkage segment that extends behind the heel of the user's foot or boot from the second anchor coupling member to the first anchor coupling member, and a first ankle cross-over segment that is releasably connected to the second middle portion, said ends and segments being contiguous in the order described. Preferably, the vertical support member comprises a calf pad. Preferably, the first ankle coupling member is also coupled to the first heel portion of the first edge or to the first middle portion of the first edge and the second ankle coupling member is also coupled to the second heel portion of the second edge or to the second middle portion of the second edge. Preferably, the linkage segments pass through a first disconnectable coupling, the second ankle coupling member, the first ankle coupling member and a second disconnectable coupling, in that order.

In another preferred embodiment, the invention is a device for retaining a boot on a sports article, the device comprising: a rear positioning element adapted to receive a rear of an upper of the boot (e.g., a vertical support member), two edges, and a plurality of linkage segments extending between the lateral edges; said plurality of linkage segments having three points of fastening to a first of the two edges and two points of fastening to a second of the two edges.

In a further embodiment, the invention is an interface system for retaining a foot or a boot on a sports article, the interface system comprising: a base structure having a first (e.g., medial) edge, a second (e.g., lateral) edge, and a heel loop connected to the first edge and the second edge; a linking member having two ends and a middle, one of the ends being fastened to the second edge, the middle being releasably connected to the second edge, extending to the first edge, around the heel of the user to the second edge and to the second end with the second end being releasably connected to the first edge. Preferably, the interface system further comprises a vertical support member that is attached to the heel loop. Preferably, the vertical support member comprises a first layer ankle a second layer, the first layer being pliable and the second layer being rigid or semi-rigid and having a cutout adjacent its base. Preferably, the interface system further comprises a first connector attached to the middle and the second edge and a second connector attached to the second end and the first edge.

In yet another preferred embodiment, the invention is an interface system for retaining a foot or a boot of a user on a sports article, the interface system comprising: a base structure consisting of a first (e.g., lateral) edge having a first back portion and a first front portion and a second (e.g., medial) edge having a second back portion and a second front portion, and a heel loop portion that is either adjustably connected to said first edge and to said second edge or is a contiguous portion of said first edge and said second edge; a vertical support member that is attached to the heel loop portion of the base structure; a first ankle coupling member; a second ankle coupling member that is coupled to the second back portion, to the heel loop portion or to the vertical support member; a first linking member comprising: a first end that is attached to the second front portion, a first toe cross over linking segment that is releasably connected to the first back portion, a first ankle cross over segment that is coupled to the second anchor coupling member, a heel linkage segment that extends behind the heel of the user's foot or boot from the second anchor coupling member to the first anchor coupling member, and a lateral primary ankle anchor segment having a second end that is fastened to the first back portion, to the heel loop or to the vertical support member, said ends and segments being contiguous in the order described; and a second lining member comprising: a first terminus that is fastened to said first ankle coupling member, and a second ankle cross over segment having a second terminus that is releasably connected to the second back portion, said termini and segments being contiguous in the order described. Preferably, the interface system further comprises: a first primary ankle anchor member by which the second ankle coupling member is coupled to the second back portion, the heel loop or the vertical support member. Preferably, the interface system further comprises: a first disconnectable coupling member and a second disconnectable coupling member. Preferably, the linkage segments pass through the first disconnectable coupling member, the second ankle coupling member, the first ankle coupling member and the second disconnectable coupling member, in that order.

In another preferred embodiment, the invention is a device for retaining a boot on a sports article, the device comprising: a rear positioning element adapted to receive a rear of an upper of the boot, two edges, and a plurality of linkage segments extending between the lateral edges; said plurality of linkage segments having three points of fastening to a first of the two edges and two points of fastening to a second of the two edges.

In a further preferred embodiment, the invention is an interface system for retaining a foot or a boot of a user on a sports article, the interface system comprising: a base structure having a first edge, a second edge, and a heel loop connected to the first edge and the second edge; a first linking member having two ends and a middle, one of the ends being fastened to the second edge, and the middle being releasably connected to the first edge, being coupled to the second edge or to the heel loop, extending around the heel of the user and terminating in the second of the ends which is fastened to the first edge or to the heel loop; a second linking member having two endings with first of the endings coupled to the first lining member and the second of the endings being releasably connected to the second edge. Preferably, the middle is coupled to the second edge by a primary ankle anchor member. Preferably, the vertical support member comprises a first layer and a second layer, the first layer being pliable and the second layer being rigid or semi-rigid and having a cutout adjacent its bottom. Preferably, the interface system further comprises a first connector attached to the middle and to the first edge and a second connector attached to the second of the endings and to the second edge.

In yet another preferred embodiment, the invention is an interface system for retaining a foot or a boot of a user on a sports article, the interface system comprising: a base structure consisting of a first edge having a first back portion and a front toe portion and a second edge having a second back portion and a second front portion, and a heel loop portion that is either adjustably connected to said first edge and to said second edge (as is the case with many traditional binding systems) or is a contiguous portion of said first edge and said second edge; a vertical support member that is attached to the base structure; a first primary ankle anchor member that is coupled to the heel loop portion or to the vertical support member; a first disconnectable coupling member that is coupled to the second back portion; a first toe anchor member that is coupled to the first front portion; a second primary ankle anchor member that is coupled to the heel loop portion or to the vertical support member; a second disconnectable coupling member that is coupled to the first back portion; a second toe anchor member that is coupled to the second front portion; a first linking member comprising: a first end that is connected to the first primary ankle anchor member, a first ankle crossover linkage segment that extends between the first primary ankle anchor member and the first disconnectable coupling member, and a first toe crossover linkage segment that extends from the first disconnectable coupling member, and a second end that is coupled to the first toe anchor member, said ends and segments being contiguous in the order described; and a second linking member comprising: a first terminus that is coupled to the second ankle coupling member, a second ankle crossover linkage segment that extends between the second ankle coupling member and the second disconnectable coupling member, and a second toe crossover linkage segment that extends from the second disconnectable coupling member, and a second terminus that is coupled to the second toe anchor member, said termini and segments being contiguous in the order described. Preferably, the interface system further comprises: a first ankle member first layer that is attached to the first edge; and a second ankle member first layer that is attached to the second edge. Preferably, the first ankle coupling member is also coupled to the first back portion and the second ankle coupling member is also coupled to the second back portion.

In another preferred embodiment, the invention is a device for retaining a boot on a sports article, the device comprising: a rear positioning element adapted to receive a rear of an upper of the boot (e.g., a vertical support member), two edges, and a plurality of linkage segments extending between the edges; a first of said plurality of linkage segments having two or more points of fastening to a first of the two edges and a single point of fastening to a second of the two edges; and a second of said plurality of linkage segments having two or more points of fastening to the second of the two edges and a single point of fastening to the first of the two edges. Preferably, the interface system further comprises: a first ankle member first layer that is attached to the first of the two edges; and a second ankle member first layer that is attached to the second of the two edges. Preferably, the interface system further comprises: a first ankle padding member that is supported one of the linkage segments; and a first toe padding member that is supported on another of the linkage segments.

In a further preferred embodiment, the invention is an interface system for retaining a foot or a boot on a sports article, the interface system comprising: a base structure having a first (e.g., lateral) edge, a second (e.g., medial) edge, and a heel loop connected to the first edge and the second edge; a first linking member having two ends and a middle, one of the ends being fastened to the heel loop or to the first edge, the other of the ends being fastened to the first edge, and the middle being slidably connected to a first connector that is releasably connected to the second edge; and a second linking member having two endings and a center, one of the endings being fastened to the heel loop or to the second edge, the other of the endings being fastened to the second edge, and the center being slidably connected to a second connector that is releasably connected to the first edge. Preferably, the interface system further comprises: a vertical support member that is attached to the heel loop; a first bumper support member that is disposed adjacent to or integral with said first edge; a second bumper support member that is disposed adjacent to or integral with said second edge; a first bumper component mounted on said first bumper support, said first bumper component being operative to adjustably limit the movement in a first direction of the heel loop and/or the vertical support member; and a second bumper component mounted on said second bumper support, said second bumper component being operative to adjustably limit the movement in a second direction of the heel loop and/or the vertical support member. Preferably, the vertical support member comprises a first layer and a second layer, the first layer being pliable and the second layer being rigid or semi-rigid and having a cutout adjacent its bottom. Preferably, the interface system further comprising: a first primary ankle anchor member that fastens one of the ends to the heel loop or to the first edge and a second primary ankle anchor member that fastens the other of the ends to the heel loop or to the second edge.

In another preferred embodiment, the invention is an interface system for retaining a foot or a boot of a user on a sports article, the interface system comprising: a base structure consisting of a first (e.g., lateral) edge having a first heel back portion and a first front portion and a second (e.g., medial) edge having a back portion and a second front portion, and a heel loop portion that is either adjustably connected to said first edge and to said second edge or is a contiguous portion of said first edge and said second edge; a vertical support member that is attached to the heel loop portion of the base structure; a first primary ankle anchor member that is coupled to the first back portion, the heel loop portion or to the vertical support member; a first disconnectable coupling member that is coupled to the second back portion; a second primary ankle anchor member that is coupled to second back portion, the heel loop portion or to the vertical support member; a second disconnectable coupling member that is coupled to the first back portion; a toe anchor member that is coupled to the second front portion; a first linking member having a first end that is connected to the first primary ankle anchor member, a first ankle crossover linkage segment that extends between the first primary ankle anchor member and the first disconnectable coupling, and a second end to which the first disconnectable coupling is attached; and a second ling member having a first terminus that is coupled to the second ankle coupling member, a second ankle crossover linkage segment that extends between the second ankle coupling member and the second disconnectable coupling member, and a second toe crossover linkage segment that extends from the second disconnectable coupling member, and a second terminus that is coupled to the second toe anchor member, said termini and segments being contiguous in the order described. Preferably, the interface system further comprises: a first ankle member first layer that is attached to the first edge; and a second ankle member first layer that is attached to the second edge. Preferably, the interface system further comprises: a first ankle coupling member and a second ankle coupling member, wherein the first ankle coupling member is also coupled to the first heel portion or to the first middle portion and the second ankle coupling member is also coupled to the second heel portion or to the second middle portion.

In a further preferred embodiment, the invention is a device for retaining a boot on a sports article, the device comprising: a rear positioning element adapted to receive a rear of an upper of the boot (e.g., a vertical support member), two edges, and a plurality of linkage segments extending between the edges; a first of said plurality of linkage segments having a single point of fastening to a first of the two edges and a single point of fastening to a second of the two edges; and a second of said plurality of linkage segments having two or more points of fastening to the second of the two edges and a single point of fastening to the first of the two edges. Preferably, the interface system further comprises: a first ankle member first layer that is attached to the first of the two edges; and a second ankle member first layer that is attached to the second of the two edges. Preferably, the interface system further comprises: a first ankle padding member that is supported one of the linkage segments; and a first toe padding member that is supported on another of the linkage segments.

In another preferred embodiment, the invention is an interface system for retaining a foot or a boot on a sports article, the interface system comprising: a base structure having a first (e.g., medial) edge, a second (e.g., lateral) edge, and a heel loop connected to the first edge and the second edge; a first lining member having two ends, a middle and a first connector, one of the ends being fastened to the heel loop or to the first edge, the other of the ends being fastened to the first edge and the middle being slidably connected to the first connector that is releasably connected to the second edge; and a second linking member having two endings and a second connector, one of the endings being fastened to the heel loop or to the second edge, the other of the endings being slidably connected to the second connector that is releasably connected to the first edge. Preferably, the interface system further comprises: a vertical support member that is attached to the heel loop; a first bumper support member that is disposed adjacent to or integral with said first edge; a second bumper support member that is disposed adjacent to or integral with said second edge; a first bumper component mounted on said first bumper support, said first bumper component being operative to adjustably limit the movement in a first direction of the heel loop and/or the vertical support member; and a second bumper component mounted on said second bumper support, said second bumper component being operative to adjustably limit the movement in a second direction of the heel loop and/or the vertical support member. Preferably, the vertical support member comprises a first layer and a second layer, the first layer being pliable and the second layer being rigid or semi-rigid and having a cutout adjacent its bottom. Preferably, the interface system further comprises: a first ankle member first layer connected to the first edge and a second ankle member first layer connected to the second edge.

In another preferred embodiment, the invention is an interface system for retaining a foot or a boot of a user on a sports article, the interface system comprising: a base structure consisting of a first (e.g., lateral) edge having a first back portion and a first front portion and a second (e.g., medial) edge having a second back portion and a second toe portion, and a heel loop portion that is either adjustably connected to said first edge and to said second edge or is a contiguous portion of said first edge and said second edge, a vertical support member that is attached to the heel loop portion, said vertical support member comprising: a bottom, a plurality of layers and a calf pad; a first ankle coupling member that is coupled to the heel loop portion; a second ankle coupling member that is coupled to the heel loop portion; a first disconnectable coupling member that is coupled to the first back portion; a second disconnectable coupling member that is coupled to the second back portion; a first ankle member first layer that is attached to said first edge; a second ankle member first layer that is attached to said second edge; a first toe anchor member that is coupled to the second toe portion; a first linking member comprising: a first end that is connected to the bottom or to the first heel portion, a first primary ankle anchor member that passes through the first ankle coupling member, a heel linkage member that passes behind the heel of the user and then passes through the second ankle coupling member, a first ankle crossover linkage segment that extends between the second ankle coupling member and the first disconnectable coupling member, and a first toe crossover linkage segment that extends from the first disconnectable coupling member to the second toe anchor member, and a second end that is connected to the first toe anchor member, said ends and segments being contiguous in the order described; a first ankle padding member that is supported on said first ankle crossover linkage segment; a first toe padding member that is supported on said first toe crossover linkage segment; a second linking member comprising: a first terminus that is coupled to the first ankle coupling member, a second ankle crossover linkage segment that extends between the second ankle coupling member and the second disconnectable coupling member, and a second terminus that coupled to the second disconnectable coupling member, said termini and segments being contiguous in the order described; and a second ankle padding member that is supported on said second ankle crossover linkage segment Preferably, the vertical support member comprises a first layer and a second layer, the first layer being pliable and the second layer being rigid or semi-rigid and having a cutout or depression adjacent its base in the area of the user's Achilles tendon. Preferably, the heel linkage member passes between the first layer and the second layer of the vertical support member. Preferably, said heel linkage member is threaded through openings in any one, two or all of the layers of the vertical support member. Preferably, said heel linkage member is fastened or bonded to any one, two or all of the layers of the vertical support member.

In a further preferred embodiment, the invention is a device for retaining a boot on a sports article, the device comprising: a rear positioning element adapted to receive a rear of an upper of the boot, two edges, and a plurality of linkage segments extending between the edges; a first of said plurality of linkage segments having two points of fastening to a first of the two edges and two points of fastening to a second of the two edges; and a second of said plurality of linkage segments having one point of fastening to the second of the edges and a single point of fastening to the first of said first of said plurality of linkage segments.

In another preferred embodiment, the invention is an interface system for retaining a foot or a boot on a sports article, the interface system comprising: a base structure having a first (e.g., medial) edge, a second (e.g., lateral) edge, and a heel loop connected to the first edge and the second edge; a first ankle coupling member; a second ankle coupling member; a first linking member having two ends and a middle, one of the ends being fastened to the heel loop or to the second edge, the other of the ends being fastened to the first edge and the middle passing through the first ankle coupling member, around the back of the heel of the user, through the second ankle coupling member, and through a first releasable connector that is releasably connected to the second edge; and a second linking member having two endings, one of the endings being fastened to the first ankle coupling member, the other of the endings being releasably connected to the first edge. Preferably, the interface system further comprises: a first ankle member first layer that is attached to the first edge; and a second ankle member first layer that is attached to the second edge. Preferably, the interface system further comprises: a vertical support member that is attached to the heel loop and wherein the vertical support member comprises a first layer and a second layer, the first layer being pliable and the second layer being rigid or semi-rigid and having a cutout adjacent its bottom. Preferably, the interface system further comprises: a first ankle padding member that is supported one of the linkage segments; and a first toe padding member that is supported on another of the linkage segments.

In yet another preferred embodiment, the invention is an interface system for retaining a foot or a boot on a sports article for a user, the interface system comprising: a base structure having a first edge having a first front portion and a first back portion, a second edge having a second front portion and a second back portion, and a heel loop connected to the first edge and the second edge; a vertical support member that is attached to the heel loop; and means for linking, the means for linking selected from the group consisting of: (1) a first linkage assembly comprising: a first linking member having two ends and a center, one of the ends being fastened to the vertical support member, the heel loop or to the first back portion, the other of the ends being fastened to the first front portion and the center being releasably connected to the second back portion, a second linking member having two endings and a middle, one of the endings being fastened to the vertical support member, the heel loop or to the second back portion, the other of the endings being fastened to the second front portion and the middle being releasably connected to the first back portion, and a third linking member extending from said one of the ends to said one of the endings; (2) a second linkage assembly comprising: a first linking member having two ends and a center, one of the ends being fastened to the vertical support member, the heel loop or to the first back portion, the other of the ends being releasably connected to the second back portion, a second lining member having two endings and a middle, one of the endings being fastened to the vertical support member, the heel loop or to the second back portion, the other of the endings being fastened to the second front portion and the middle being releasably connected to the first back portion, and a third linking member extending from said one of the ends to said one of the endings; (3) a third linkage assembly comprising: a first liking member having two ends and a center, one of the ends being fastened to the vertical support member, the heel loop or to the first back portion, the other of the ends being fastened to the first front portion and the center being releasably connected to the second back portion, and a second linking member having two endings and a middle, one of the endings being fastened to the vertical support member, the heel loop or to the second back portion, the other of the endings being fastened to the second front portion and the middle being releasably connected to the first heel portion; (4) a fourth linkage assembly comprising: a first linking member having two ends and a center, one of the ends being fastened to the vertical support member, to the heel loop or to the first back portion, the other of the ends being releasably connected to the second back portion, and a second linking member having two endings and a middle, one of the endings being fastened to the vertical support member, the heel loop or to the second back portion, the other of the endings being fastened to the second toe portion and the middle being releasably connected to the first back portion; (5) a fifth linkage assembly comprising: a first ankle coupling member that is coupled to the vertical support member, to the heel loop or to the first back portion, a second ankle coupling member that is coupled to the vertical support member, to the heel loop or to the first back portion, a first disconnectable coupling member that is coupled to the first back portion, a second disconnectable coupling member that is coupled to the second back portion, a first toe anchor member that is coupled to the second front portion, a first linking member having a first segment end that is connected to the vertical support member, to the heel loop or to the first back portion, a first primary ankle anchor segment that passes through the first ankle coupling member, a heel linkage segment that passes behind the heel of the user and then passes through the second ankle coupling member, a first ankle crossover linkage segment that extends between the second ankle coupling member and the first disconnectable coupling member, and a first toe crossover linkage segment that extends from the first disconnectable coupling member to the second toe anchor member and a second segment end that is connected to the first toe anchor member, said ends and segments being contiguous in the order described, and a second linking member having a first terminus that is coupled to the first ankle coupling member, a second ankle crossover linkage segment that extends between the second ankle coupling member and the second disconnectable coupling member, and a second terminus that is coupled to the second disconnectable coupling member, said termini and segments being contiguous in the order described; and (6) a sixth linkage assembly comprising: a first anchor coupling member that is fastened to the vertical support member, the heel loop or the first back portion, a second anchor coupling member that is fastened to the vertical support member, the heel loop or the second back portion, and a single lining member having a first termination that is attached to the second front portion, a first segment that is releasably connected to the first back portion, a second segment that is fastened to the second anchor coupling member, a third segment that extends between the second anchor coupling member to the first anchor coupling member and a second termination that is releasably connected to the second back portion, said terminations and segments being contiguous in the order described.

In another preferred embodiment, the invention is an interface system for retaining a foot or a boot on a sports article for a user, the interface system comprising: a base structure having a first edge having a first front portion and a first back portion, a second edge having a second front portion and a second back portion, and a heel loop connected to the first edge and the second edge; a vertical support member that is attached to the heel loop; and means for lining, the means for linking selected from the group consisting of: (1) a first linkage assembly comprising: a first making member having two ends and a center, one of the ends being fastened to the vertical support member, the heel loop or to the first back portion, the other of the ends being fastened to the first front portion and the center being releasably connected to the second back portion, a second linking member having two endings and a middle, one of the endings being fastened to the vertical support member, the heel loop or to the second back portion, the other of the endings being fastened to the second front portion and the middle being releasably connected to the first back portion, and a third linking member extending from said one of the ends to said one of the endings; (2) a second linkage assembly comprising: a first linking member having two ends and a center, one of the ends being fastened to the vertical support member, the heel loop or to the first back portion, the other of the ends being releasably connected to the second back portion, a second linking member having two endings and a middle, one of the endings being fastened to the vertical support member, the heel loop or to the second back portion, the other of the endings being fastened to the second front portion and the middle being releasably connected to the first back portion, and a third lining member extending from said one of the ends to said one of the endings; (3) a third linkage assembly comprising: a first lining member having two ends and a center, one of the ends being fastened to the vertical support member, the heel loop or to the first back portion, the other of the ends being fastened to the first front portion and the center being releasably connected to the second back portion, and a second linking member having two endings and a middle, one of the endings being fastened to the vertical support member, the heel loop or to the second back portion, the other of the endings being fastened to the second front portion and the middle being releasably connected to the first heel portion; (4) a fourth linkage assembly comprising: a first linking member having two ends and a center, one of the ends being fastened to the vertical support member, to the heel loop or to the first back portion, the other of the ends being releasably connected to the second back portion, and a second linking member having two endings and a middle, one of the endings being fastened to the vertical support member, the heel loop or to the second back portion, the other of the endings being fastened to the second toe portion and the middle being releasably connected to the first back portion; and (5) a fifth linkage assembly comprising: a first ankle coupling member that is coupled to the vertical support member, to the heel loop or to the first back portion, a second ankle coupling member that is coupled to the vertical support member, to the heel loop or to the first back portion, a first disconnectable coupling member that is coupled to the first back portion, a second disconnectable coupling member that is coupled to the second back portion, a first toe anchor member that is coupled to the second front portion, a first linking member having a first segment end that is connected to the vertical support member, to the heel loop or to the first back portion, a first primary ankle anchor segment that passes through the first ankle coupling member, a heel linkage segment that passes behind the heel of the user and then passes through the second ankle coupling member, a first ankle crossover linkage segment that extends between the second ankle coupling member and the first disconnectable coupling member, and a first toe crossover linkage segment that extends from the first disconnectable coupling member to the second toe anchor member and a second segment end that is connected to the first toe anchor member, said ends and segments being contiguous in the order described, and a second linking member having a first terminus that is coupled to the first ankle coupling member, a second ankle crossover linkage segment that extends between the second ankle coupling member and the second disconnectable coupling member, and a second terminus that coupled to the second disconnectable coupling member, said termini and segments being contiguous in the order described. Preferably, the interface system further comprises: a first ankle member first layer that is attached to the first edge; and a second ankle member first layer that is attached to the second edge. Preferably, the interface system further comprises: a first ankle padding member that is supported one of the linkage segments; and a first toe padding member that is supported on another of the linkage segments. Preferably, the interface system further comprises: a first bumper support member that is disposed adjacent to or integral with said first edge; a second bumper support member that is disposed adjacent to or integral with said second edge; a first bumper component mounted on said first bumper support, said first bumper component being operative to adjustably limit the movement in a first direction of the heel loop and/or the vertical support member; and a second bumper component mounted on said second bumper support, said second bumper component being operative to adjustably limit the movement in a second direction of the heel loop and/or the vertical support member.

In a preferred embodiment, the invention is an interface system for retaining a foot or a boot on a sports article for a user, the interface system comprising: a base structure having a first edge having a first front portion and a first back portion, a second edge having a second front portion and a second back portion, and a heel loop connected to the first edge and the second edge; a vertical support member that is attached to the heel loop; and means for linking the first edge and the second edge that is operative to secure the foot or boot in the interface system; said system further comprising: a first bumper support member that is disposed adjacent to or integral with said first edge; a second bumper support member that is disposed adjacent to or integral with said second edge; a first bumper component mounted on said first bumper support, said first bumper component being operative to limit the movement in a first direction of the heel loop and/or the vertical support member; and a second bumper component mounted on said second bumper support, said second bumper component being operative to limit the movement in a second direction of the heel loop and/or the vertical support member.

In another preferred embodiment, the invention is an interface system for retaining a foot or a boot on a sports article, the interface system comprising: a base structure having a first edge having a middle portion and a front portion and a second edge having a central portion and a forward portion; a heel loop connected to the first edge and the second edge; a vertical support member that is attached to the heel loop;

a first ankle coupling member (e.g., D-ring) that is attached to the first edge or to the first edge and the heel loop; a second ankle coupling member attached to the second edge or to the second edge and the heel loop; and a single linking member having a first end that is attached to the front portion, a first segment that is releasably connected to the central portion, a second segment that is fastened to said first ankle coupling member, a third segment that is fastened to said vertical support member, a fourth segment that is fastened to the second ankle coupling member and a fifth segment that is releasably connected to the middle portion and a second end that is attached to the forward portion, said ends and segments being contiguous in the order described. Preferably, the vertical support member comprises a first layer and a second layer, the first layer being pliable and the second layer being rigid or semi-rigid and having a cutout adjacent its base. Preferably, the single linkage member is passed between the first layer and the second layer of the vertical support member. Preferably, the single linkage member is threaded through openings in any one, two or all of the layers of the vertical support member.

In yet another preferred embodiment, the invention is a combination comprising: a sports article (e.g., a snowboard); and an interface system disclosed herein. In another preferred embodiment, the invention is a combination comprising: a sports article (e.g., a snowboard); a boot; and an interface system disclosed herein. In a preferred embodiment, the invention is, in combination, a pair of the combinations disclosed herein.

In another preferred embodiment, the invention is an interface system for retaining a foot or a boot on a sports article, the interface system comprising: a base structure having a first edge having a middle portion and a front portion and a second edge having a central portion and a forward portion; a heel loop connected to the first edge and the second edge; a vertical support member that is attached to the heel loop; and means for linking, the means for linking selected from the group consisting of: (1) a first linkage assembly comprising: a first linking member having two ends and a middle portion, one of the ends being fastened to the heel loop or to the first edge, the other of the ends being fastened to the first edge and the middle portion being releasably connected to the second edge and a second linking member having two endings and a central portion, one of the endings being fastened to the heel loop or to the second edge, the other of the endings being fastened to the second edge and the central portion being releasably connected to the first edge; (2) a second linkage assembly comprising: a single linking member having a first end that is attached to the vertical support member, a first segment that is releasably connected to the central portion, a second segment that is fastened to said front portion, a third segment that is fastened to said vertical support member, a fourth segment that is fastened to the forward portion, a fifth segment that is releasably connected to the middle portion and a second end that is attached to the vertical support member, said segments and ends being contiguous in the order described; and (3) a third linkage assembly comprising: a first ankle coupling member that is attached to said first edge, a second ankle coupling member that is attached to said second edge, and a single linking member having a first end that is attached to the front portion, a first segment that is releasably connected to the central portion, a second segment that is fastened to said first ankle coupling member, a third segment that is fastened to said vertical support member, a fourth segment that is fastened to the second ankle coupling member, a fifth segment that is releasably connected to the middle portion and a second end that is attached to the forward portion, said ends and segments being contiguous in the order described.

In a further preferred embodiment, the invention is an interface system for retaining a foot or a boot of a user on a sports article, the interface system comprising: a base structure having a first edge having a first front portion and a first back portion, a second edge having a second front portion and a second back portion, and a heel loop connected to the first edge and the second edge; a vertical support member that is attached to the heel loop; and means for linking the first edge and the second edge that is operative to secure the foot or boot in the interface system, said means for linking comprising: a plurality of linking segments; said system further comprising: a first ankle member first layer that is attached to the first edge; and a second ankle member first layer that is attached to the second edge.

In another preferred embodiment, the invention is an interface system for retaining a foot or a boot of a user on a sports article, the interface system comprising: a base structure having a first edge having a first front portion and a first back portion, a second edge having a second front portion and a second back portion, and a heel loop connected to the first edge and the second edge; a vertical support member that is attached to the heel loop; and means for linking the first edge and the second edge that is operative to secure the foot or boot in the interface system; said system further comprising: a first bumper support member that is disposed adjacent to or integral with said first edge; a second bumper support member that is disposed adjacent to or integral with said second edge; a first bumper component mounted on said first bumper support, said first bumper component being operative to adjustably limit the movement in a first direction of the heel loop and/or the vertical support member; and a second bumper component mounted on said second bumper support, said second bumper component being operative to adjustably limit the movement in a second direction of the heel loop and/or the vertical support member.

In another preferred embodiment, the invention is an interface system for retaining a foot or a boot of a user on a sports article, the interface system comprising: a base structure having a first edge having a first front portion and a first back portion, a second edge having a second front portion and a second back portion, and a heel loop connected to the first edge and the second edge; a vertical support member that is attached to the heel loop; and means for making the first edge and the second edge that is operative to secure the foot or boot in the interface system; said system further comprising: a tool mounted on the vertical support member. Preferably, the tool is mounted in a mounting sheath that is either an integral part of the vertical support member or attached to it

The system may be mounted (secured) to a snowboard in the same manner as is the case with many conventional strap binding. Gross adjustment of the system (for different boot sizes) is accomplished first by setting the heel loop member of the base structure to the appropriate position with respect to the base member (as with many conventional bindings.) Then, the appropriate length of each linkage member is threaded through its respective gross linkage adjustment member. In the case of a single piece base and heel loop member, gross adjustment of heel loop position is not applicable.

To put on the binding, the user first places his foot (or boot) in the foot-bed, then wraps either the lateral or medial linkage member or portion of a single linkage member over the foot (or boot) and engages its respective portion of the entry/exit mechanism to the associated portion of the entry/exit mechanism on the opposing edge. The user then performs the same operation for the remaining linkage member or portion of the single linkage member. Once this is completed, the user may adjust the tension of each linkage member or portion of the single linkage member by using the tension adjustment member on the appropriate entry/exit mechanism in a similar way as with a conventional strap binding. Exiting from the system is performed by reversing the procedure described above.

Further aspects of the invention will become apparent from consideration of the drawings and the ensuing description of preferred embodiments of the invention. A person skilled in the art will realize that other embodiments of the invention are possible and that the details of the invention can be modified in a number of respects, particularly with respect to the various coupling and interface connections, all without departing from the concept. Thus, the following drawings and description are to be regarded as illustrative in nature and not restrictive.

### BRIEF DESCRIPTION OF THE DRAWINGS

The features of the invention are better understood by reference to the accompanying drawings, which illustrate presently preferred embodiments of the invention. All drawings presented herein illustrate a right-footed device, with the understanding that a left-footed device is symmetrical to, or a copy of the right-footed device illustrated herein Selected components have been removed from relevant views to better clarify the illustrations. Some of the drawings may contain features which are not used in certain embodiments but are present in the figure used to describe such an embodiment

FIG. 1 is a perspective view of a preferred embodiment of the invention.

FIG. 2 is a perspective view of another preferred embodiment of the invention.

FIG. 3 is a perspective view of another preferred embodiment of the invention.

FIG. 4 is a perspective view of another preferred embodiment of the invention.

FIG. 5 is a perspective view of another preferred embodiment of the invention.

FIG. 6 is a perspective view of another preferred embodiment of the invention.

FIG. 7 is a perspective view of a preferred configuration of component connections in the vicinity of the heel loop.

FIG. 8 is a perspective view of another preferred configuration of component connections in the vicinity of the heel loop.

FIG. 9 is a perspective view of another preferred configuration of component connections in the vicinity of the heel loop.

FIG. 10 is a side view of another preferred configuration of component connections in the vicinity of the heel loop.

FIG. 11 is a side view of another preferred configuration of component connections in the vicinity of the heel loop.

FIG. 12 is a side view of another preferred configuration of component connections in the vicinity of the heel loop.

FIG. 13 is a side view of another preferred configuration of component connections in the vicinity of the heel loop.

FIG. 14 is a side view of another preferred configuration of component connections in the vicinity of the heel loop.

FIG. 15 is a side view of another preferred configuration of component connections in the vicinity of the heel loop.

FIG. 16 is a side view of another preferred configuration of component connections in the vicinity of the heel loop.

FIG. 17 is a side view of another preferred configuration of component connections in the vicinity of the heel loop.

FIG. 18 is a side view of another preferred configuration of component connections in the vicinity of the heel loop.

FIG. 19 is a side view of another preferred configuration of component connections in the vicinity of the heel loop.

FIG. 20 is a side view of another preferred configuration of component connections in the vicinity of the heel loop.

FIG. 21 is a side view of another preferred configuration of component connections in the vicinity of the heel loop.

FIG. 22 is a side view of another preferred configuration of component connections in the vicinity of the heel loop.

FIG. 23 is a side view of another preferred configuration of component connections in the vicinity of the heel loop.

FIG. 24 is a side view of another preferred configuration of component connections in the vicinity of the heel loop.

FIG. 25 is a side view of another preferred configuration of component connections in the vicinity of the heel loop.

FIG. 26 is a side view of another preferred configuration of component connections in the vicinity of the heel loop.

FIG. 27 is a side view of another preferred configuration of component connections in the vicinity of the heel loop.

FIG. 28 is a side view of another preferred configuration of component connections in the vicinity of the heel loop.

FIG. 29 is a side view of another preferred configuration of component connections in the vicinity of the heel loop.

FIG. 30 is a side view of another preferred configuration of component connections in the vicinity of the heel loop.

FIG. 31 is a side view of another preferred configuration of component connections in the vicinity of the heel loop.

FIG. 32 is a side view of another preferred configuration of component connections in the vicinity of the heel loop.

FIG. 33 is a side view of another preferred configuration of component connections in the vicinity of the heel loop.

FIG. 34 is a side view of a preferred locking component mounted on the lateral and/or medial ankle coupling member.

FIG. 35 is a side view showing a preferred embodiment of tensioning knob intersecting the lateral heel linkage member segment and/or the medial heel linkage member segment

FIG. 36 is a top/front view of a preferred embodiment of the interface system in the open position.

FIG. 37 is a top/front view of a preferred embodiment of the interface system in the closed position.

FIG. 38 is an exploded view of the first layer and the second layer of the vertical support member in a preferred embodiment of the invention.

FIG. 39 is a perspective view of the flex bumper and the flex bumper mounting slot of a preferred embodiment of the invention.

FIG. 40 is a perspective view of the flex bumper and the flex bumper mounting slot of a preferred embodiment of the invention

FIG. 41 is side view of the adaptive base structure of a preferred embodiment of the invention.

FIG. 42 is a back view of the adaptive base structure of a preferred embodiment of the invention.

FIG. 43 is a perspective view showing the principle components of the first layer of a preferred embodiment of the invention.

FIG. 44 is a perspective view showing the multi-tool mounted on the vertical support member in its mounting sheath in a preferred embodiment of the invention.

The following reference numerals are used to indicate the parts and environments of the invention on the drawings:
1 interface system, system, device
4 rigid base structure, base structure
6 lateral back portion
7 lateral edge of base structure
9 lateral front portion
10 medial edge of base structure
11 medial back portion
13 vertical support member
14 medial front portion
15 bottom
16 calf pad
19 lateral disconnectable coupling mechanism base, lateral female portion
22 medial disconnectable coupling mechanism base, medial female portion
23 lateral disconnectable coupling tongue, lateral male portion
24 medial disconnectable coupling tongue, medial male portion
25 lateral disconnectable coupling member, lateral connector
28 medial disconnectable coupling member, medial connector
30 heel linkage member, heel linkage segment
31 lateral heel linkage member segment, lateral segment
34 medial heel linkage member segment, medial segment
37 lateral primary ankle anchor member, lateral primary ankle anchor segment
40 medial primary ankle anchor member
43 lateral secondary ankle anchor link
45 second end
46 medial secondary ankle anchor link
47 first end
48 lateral linkage member, lateral linking member
49 lateral ankle crossover linkage segment
50 first terminus
51 medial linkage member, medial lining member
52 medial ankle crossover linkage segment
53 single linking member, one-piece linking member
55 lateral ankle coupling member
58 medial ankle coupling member
61 lateral toe crossover linkage segment
64 medial toe crossover linkage segment
65 second terminus
67 lateral toe anchor member
70 medial toe anchor member
73 heel loop portion, heel loop
76 heel member first layer
77 heel member second layer
79 lateral ankle member first layer
82 medial ankle member first layer
91 lateral ankle padding member
94 medial ankle padding member
100 medial toe padding member
103 cutout or depression
106 shaded region of coupling mounting locations on base wall
109 locking member
112 tensioning knob
115 pulley/guide member
118 first flex bumper, first bumper component
121 second flex bumper, second bumper component
122 bumper release lever
124 lateral flex bumper support member, bumper support member, rigid support member
127 medial flex bumper support member
130 first slot
133 second slot
136 angle
139 multi-tool
142 multi-tool mounting sheath

### BEST MODES FOR CARRYING OUT THE INVENTION

It is noted that only a right-footed embodiment is disclosed herein with the understanding that a similar device would be provided for the left foot, being anatomically symmetric to the right-footed device, or being a copy of the same device.

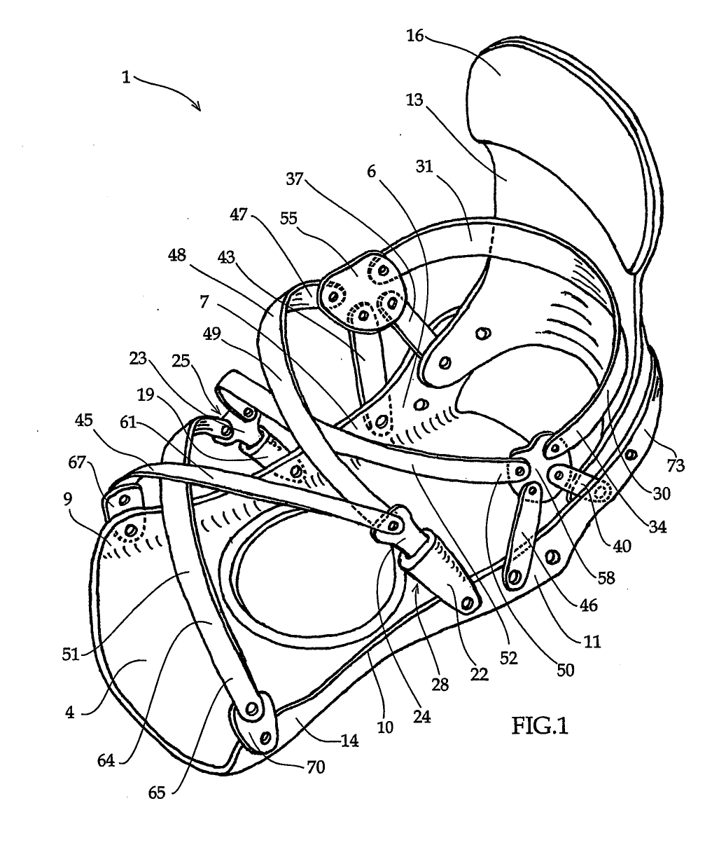

Referring to FIG. 1, a preferred embodiment of interface system 1 is presented. In this embodiment, interface system 1 preferably comprises rigid base structure 4, vertical support member 13, and three pliable linkage members: lateral linkage member 48, medial linkage member 51 and heel linkage member 30.

Base structure 4 preferably comprises (1) lateral edge 7 having lateral back portion 6 and lateral front portion 9, (2) medial edge 10 having medial back portion 11 and medial front portion 14, and (3) heel loop portion 73. Preferably, heel loop portion 73 is adjustably connected to rigid base structure 4 by conventional means, e.g., bolts or rivets. Alternatively, rigid base structure 4 and heel loop portion 73 are molded as one piece. Thus, heel loop portion 74 is either adjustably connected to lateral edge 7 and to medial edge 10 (as is the case with many traditional binding systems), or is a contiguous portion of lateral edge 7 and medial edge 10. Vertical support member 13 is preferably attached to heel loop portion 74 of base structure 4.

Preferably, lateral ankle coupling member 55 is coupled to one side of heel loop portion 73 of base structure 4 or to vertical support member 13 and is oriented upwards. Similarly, medial ankle coupling member 58 is coupled to the other side of heel loop portion 73 of base structure 4 or to vertical support member 73 and is also oriented upwards. Preferably, lateral ankle coupling member 55 is located approximately at (Oust above) the tip of the lateral malleoli (of the foot) the outer surface of the boot and medial ankle coupling member 58 is located approximately at (Oust below) the tip of the medial malleoli (of the foot) at the outer surface of the boot

In a preferred embodiment, lateral ankle coupling member 55 is connected to heel loop portion 73 by means of primary lateral ankle anchor link 37 and to lateral back portion 6 of lateral edge 7 by means of secondary lateral ankle anchor link 43. Similarly, medial ankle coupling member 58 is connected to heel loop portion 73 by means of primary ankle anchor link 40 and to medial back portion 11 of medial edge 10 by means of secondary medial ankle anchor link 46. In preferred embodiments, secondary lateral ankle anchor link 43 and secondary medial ankle anchor link 46 are stretchable members, e.g., members comprising: a spring or an elastic (bungee) cord, with straps to limit the extent to which the members can stretch. In an alternative embodiment, any of the members, links and/or linkages is stretchable.

Preferably, linkage members 48, 51 and 30 are comprised or lengths or woven fabric (flat or tubular) made of a suitable material, such as nylon, Vectran®, or Aramid®D fiber. Commercially available woven nylon webbing is especially preferred. Linkage members 48, 51 and 30 may also be constructed of a generally flat, flexible plastic material such as HDPE or ABS, etc., in which case, the linkage members may have some anatomically directed shape. In alternative embodiments, linkage members are constructed of steel cable or cord.

It is further noted that only a right-footed embodiments are disclosed herein with the understanding that a similar device would be provided for the left foot, the left-footed device being anatomically symmetric to the right-footed device, being a mirror image or being a copy of the same device.

Lateral lining member 48 Comprises first end 47 that is connected to lateral ankle coupling member 55, lateral ankle crossover linkage segment 49 that extends between lateral ankle coupling member 55 and medial disconnectable coupling member 28, and lateral toe crossover linkage segment 61. Medial disconnectable coupling member 28 is coupled to medial back portion 11 of medial edge 10. Lateral toe crossover linkage segment 61 extends between medial connectable coupling member 28 and second end 45 that is coupled to lateral front portion 9 of lateral edge 7 by means of lateral toe anchor member 67. Preferably, lateral toe anchor member 67 is located approximately at the metatarsal break of the foot

Medial linking member 51 comprises first terminus 50 that is coupled to medial ankle coupling member 58, medial ankle crossover linkage segment 52 that extends between medial ankle coupling member 58 and lateral disconnectable coupling member 25 and medial toe crossover linkage segment 64. Lateral disconnectable coupling member 25 is coupled to lateral back portion 6 of lateral edge 7 of base structure 4. Medial toe crossover linkage segment 64 extends between lateral disconnectable coupling member 25 and second terminus 65 that is coupled to medial front portion 14 of medial edge 10 by means of medial toe anchor member 70. Preferably, medial toe anchor member 70 is located approximately at the metatarsal break of the foot

The third linkage member is heel linkage member 30. Heel linkage member 30 preferably comprises lateral segment 31 and medial segment 34 and extends between lateral ankle coupling member 55 and medial ankle coupling member 58.

In use, lateral linkage member 48 extends around the front/top of the user's boot (not shown), and connects to medial disconnectable coupling member 28. Medial disconnectable coupling member 28 preferably has medial female portion 22 and medial male portion 24, provides a disconnectable and tension-adjustable interface between lateral linkage member 48 and rigid base structure 4. Lateral linkage member 48 then continues around the front/top of the user's boot (not shown) and is threaded through or attached to lateral toe anchor coupling member 67. Lateral toe anchor coupling member 67 is preferably located in general alignment with the metatarsal break of the user's foot (not shown), and on the same side as the origin of lateral linkage member 48. Lateral toe anchor coupling member 67 is preferably connected to rigid base structure 4 in a similar manner to the manner in which lateral ankle coupling member 55 is fastened to rigid base structure 4 (e.g., with a bolt or rivet).

Any conventional or unanticipated fastener, buckle or ratchet means deemed appropriate by one having ordinary skill in the art may be used to provide lateral disconnectable coupling member 25 and medial disconnectable coupling member 28. For example, the buckle or clip disclosed in U.S. Pat. No. 6,293,566 may be used. Alternatively, the latch disclosed in U.S. Patent Application Publication No. 2001/0009320 or the buckle disclosed in U.S. Pat. No. 6,206,403 may be used. In an alternative embodiment, the Velro® fastening system is used.

One having ordinary skill in the art will recognize that any appropriate method can be used to interface linkage segments to anchor and/or coupling components. Furthermore, segments and members may integral with a linkage segment and anchor/coupling member being one piece or integrated layers of a composite member. Linkage assembly components may be made of any suitable material or composite of materials, including metal cable, strap, or belting, woven fabric, etc. Any slots through which linkage assembly components are threaded may have rollers or caps applied to them in order to reduce the frictional forces applied to the linkage members. Moreover, in the case of a round linkage member (e.g., cable) the slots may contain or be replaced with pulleys or other suitable features capable of routing the linkage member in the described fashion.

Referring to FIG. 2, another preferred embodiment of the invention is illustrated. In this embodiment, the lateral and medial linking members are dissimilar. Preferably, interface system 1 comprises base structure 4, vertical support member 13, lateral ankle coupling member 55, medial ankle coupling member 58, lateral linkage member 48, medial linkage member 51 and heel linkage member 30.

Base structure 4 preferably comprises lateral edge 7, medial edge 10, and heel loop portion 73. Heel loop portion 73 is either adjustably connected to lateral edge 7 and to medial edge 10, or is a contiguous portion of lateral edge 7 and medial edge 10. Vertical support member 13 is preferably attached to heel loop portion 74 of base structure 4.

Lateral ankle coupling member 55 is coupled to one side of heel loop portion 73 of base structure 4 or to vertical support member 13 and is located above lateral edge 7. Similarly, medial ankle coupling member 58 is coupled to the other side or heel loop portions 75 or base structure 4 or to vertical support member 73 and is also located above medial edge 10. Lateral linking member 48 comprises first end 47 that is coupled to lateral ankle coupling member 55, and lateral ankle crossover linkage segment 49 that extends between lateral ankle coupling member 55 and lateral disconnectable coupling member 28 that is coupled to medial back portion 11 of medial edge 10 of base structure 4.

Medial lining member 51 comprises first terminus 50 that is connected to medial ankle coupling member 58, medial ankle crossover linkage segment 52 that extends between medial ankle coupling member 58 and lateral disconnectable coupling member 25 and second end that is connected to lateral disconnectable coupling member 25. Lateral disconnectable coupling member 25 is coupled to lateral back portion 6 of lateral edge 7 of base structure 4. Heel linkage member 30 extends between and is connected to lateral ankle coupling member 55 and medial ankle coupling member 58.

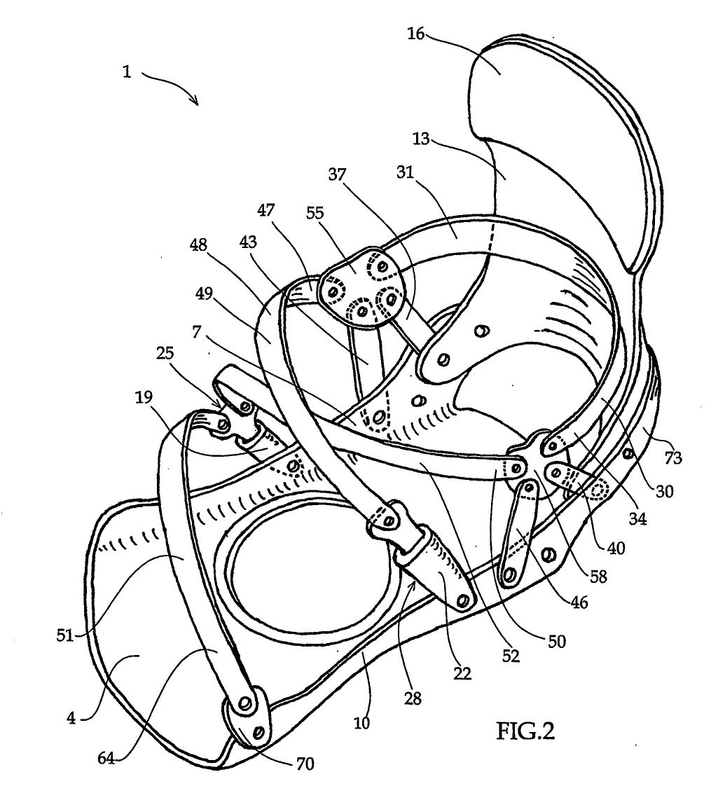

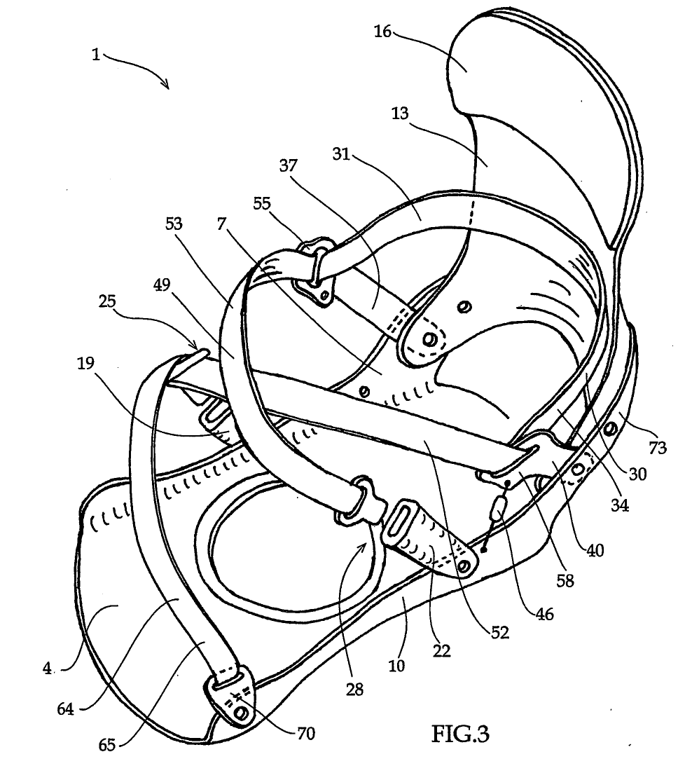

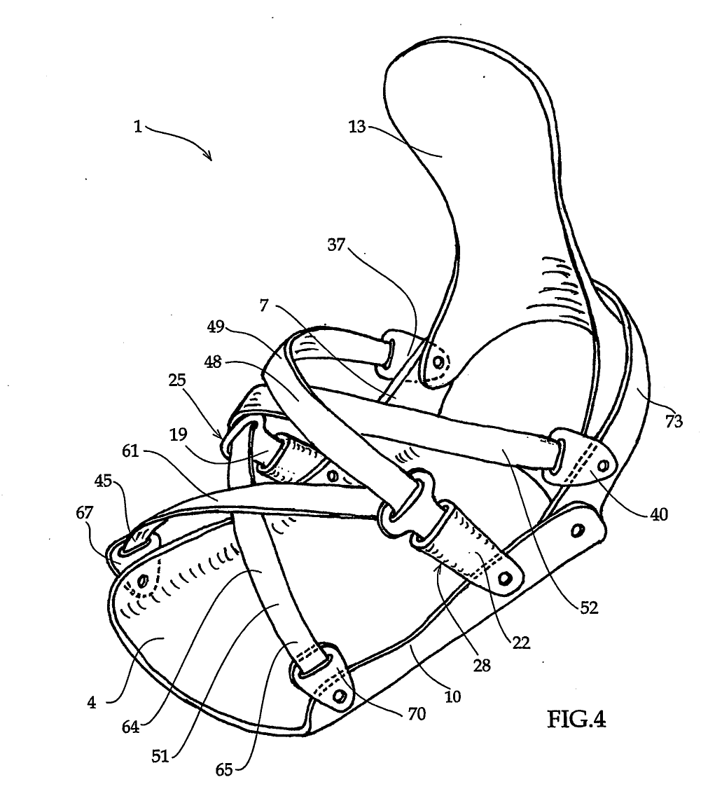

In this embodiment, one-piece linking member 53 is preferably a one-piece length of woven fabric, (or a generally flat, flexible plastic material, in which case the member may have some anatomically directed shape as its outline) originating at medial toe anchor member 70. In an alternative embodiment, one-piece linking member 53 originates on the lateral side at lateral toe anchor member 67 (not shown on FIG. 3 but shown on FIG. 4) and follows a similar path around the boot In the embodiment shown in FIG. 3, one-piece linking member 53 then crosses over the front/top of the boot (not shown) and passes through a slot in lateral disconnectable coupling member 25. After this point, one-piece lining member 53 extends around the front/top of the boot (not shown) and passes through medial ankle coupling member 58. After passing through medial ankle coupling member 58, one-piece linking member 53 continues up and back to wrap around the back of the boot (not shown). In an alternative embodiment, one-piece liking member here interfaces with one, two or all layers of vertical support member 13. After wrapping around the back of the boot, one-piece linking member 53 passes through lateral ankle coupling member 55, extends around the front/top of the boot (not shown) and connects to medial disconnectable coupling member 28.

Both lateral ankle coupling member 55 and medial ankle coupling member 58 are preferably attached to rigid base 4 and/or heel loop portion 73 and/or any combination of the layers of vertical support member 13. Alternatively, lateral ankle coupling member 55 and medial ankle coupling member 58 may be permanently fastened to, or be part of lateral primary ankle anchor member 37, medial primary ankle anchor member 40, lateral secondary ankle anchor link 43 and/or medial secondary ankle anchor link 46.

Referring to FIG. 3, another preferred embodiment of the invention is illustrated. Preferably, interface system 1 comprises base structure 4, vertical support member 13, lateral ankle coupling member 55, medial ankle coupling member 58, lateral linking member 48 and medial linking member 51.

Base structure 4 preferably comprises lateral edge 7, medial edge 10, and heel loop portion 73. Heel loop portion 73 is either adjustably connected to lateral edge 7 and to medial edge 10, or is a contiguous portion of lateral edge 7 and medial edge 10. Vertical support member 13 is preferably attached to heel loop portion 74 of base structure 4. Lateral ankle coupling member 55 and medial ankle coupling member 58 are coupled to heel loop portion 73 or to vertical support member 13.

In a preferred embodiment, medial linking member 51 comprises second terminus 65 that is attached to medial front portion 14, medial toe cross over linking segment 64 that is releasably connected to lateral back portion 6, medial ankle cross over segment 52 that is coupled to medial anchor coupling member 58, heel linkage segment 30 that extends behind the heel of the user's foot or boot from medial anchor coupling member 58 to the lateral anchor coupling member 55, and lateral primary ankle anchor segment 37 having a second end that is fastened to the lateral back portion 6, to heel loop 73 or to vertical support member 13. Lateral linking member 48 comprises first terminus 47 that is fastened to lateral ankle coupling member 55, and lateral ankle cross over segment 49 having a second terminus that is releasably connected to medial back portion 11.

In an alternative embodiment, only a single linking member is provided. Single linking member 53 comprises lateral linkage member 48, medial linkage member 51 and heel linkage member 30.

Single linking member 53 comprises a first end that is attached to medial toe portion 14 by means of medial toe anchor member 70, medial toe cross over linkage segment 64 that is releasably connected to lateral back portion 6 by means of a slidably attachment to lateral disconnectable coupling member 25, medial ankle cross over linkage segment 52 that passes through a slot in (and is thereby slidably attach ed to) medial anchor coupling member 58, heel linkage segment 30 that extends behind the heel of the user's foot or boot (not shown) from medial anchor coupling member 58 to the lateral anchor coupling member 55 and passes through a slot in (and is thereby slidably attached to) lateral anchor coupling member 55, and lateral ankle cross over segment 49 that is releasably connected at medial terminus 65 to medial back portion 11 by means of a slidable attachment to medial disconnectable coupling member 28, said ends and segments being contiguous in the order described.

Referring to FIG. 4, another preferred embodiment of interface system 1 is presented. In this embodiment, interface system 1 preferably comprises rigid base structure 4, vertical support member 13, and two pliable linkage members: lateral linkage member 48 and medial linkage member 51.

Base structure 4 preferably comprises lateral edge 7, medial edge 10, and heel loop portion 73. Heel loop portion 73 is either adjustably connected to lateral edge 7 and to medial edge 10, or is a contiguous portion of lateral edge 7 and medial edge 10. Vertical support member 13 is preferably attached to heel loop portion 73 of base structure 4. Lateral primary ankle anchor member 37 and medial primary ankle anchor member 40 are coupled to heel loop portion 73 or to vertical support member 13.

Lateral linkage member 48 comprises first end 47 that is connected to heel loop 73 by means of lateral primary ankle anchor member 37, lateral ankle crossover linkage segment 49 that extends between lateral primary ankle anchor member 37 and medial disconnectable coupling member 28, lateral toe crossover linkage segment 61 and second end 45 that is connected to lateral front portion 9 by means of lateral toe anchor member 67. Medial disconnectable coupling member 28 is coupled to medial back portion 11.

Medial linkage member 51 comprises first terminus 50 that is coupled to heel loop 73 by means of medial primary ankle anchor member 40, medial ankle crossover linkage segment 52 that extends between medial ankle coupling member 58 and lateral disconnectable coupling member 25, medial toe crossover linkage segment 64 and second terminus 65. Lateral disconnectable coupling member 25 is coupled to lateral back portion 6 of lateral edge 7 of base structure 4. Medial toe crossover linkage segment 64 extends between lateral disconnectable coupling member 25 and second terminus 65 that is coupled to medial front portion 14 of medial edge 10. Preferably, lateral disconnectable coupling member 25 and medial disconnectable coupling member 28 are slidably attached to their associated linkage members.

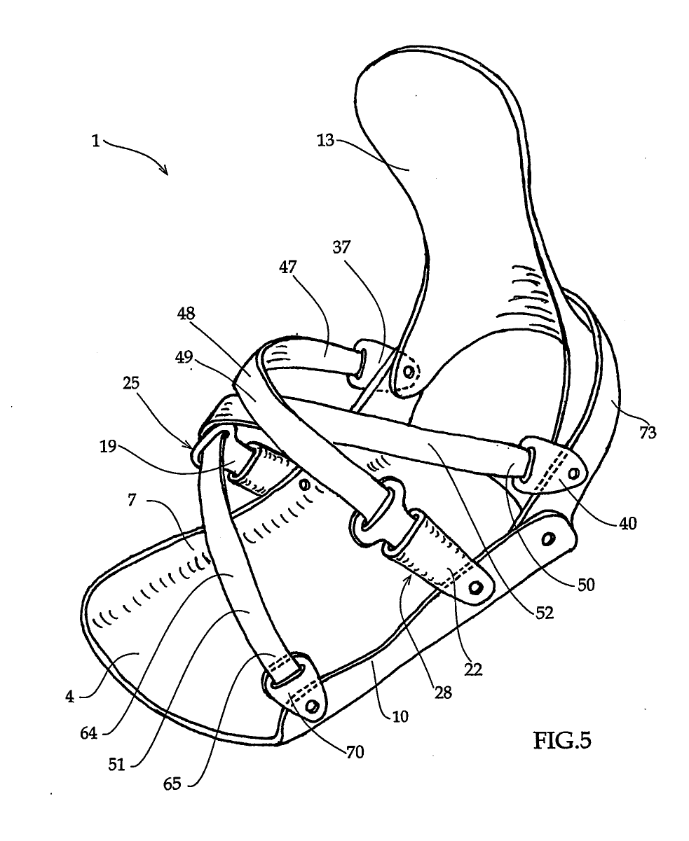

Referring to FIG. 5, another preferred embodiment of interface system 1 is presented. In this embodiment, interface system 1 preferably comprises rigid base structure 4, vertical support member 13, and two pliable linkage members: lateral linkage member 48 and medial linkage member 51.

Base structure 4 preferably comprises lateral edge 7, medial edge 10, and heel loop portion 73. Heel loop portion 73 is either adjustably connected to lateral edge 7 and to medial edge 10, or is a contiguous portion of lateral edge 7 and medial edge 10. Vertical support member 13 is preferably attached to heel loop portion 74 of base structure 4. Lateral primary ankle anchor member 37 and medial primary ankle anchor member 40 are coupled to heel loop portion 73 or to vertical support member 13.

Lateral linking member 48 comprises first end 47 that is connected to heel loop 73 by means of lateral primary ankle anchor member 37, and lateral ankle crossover linkage segment 49 that extends between lateral primary ankle anchor member 37 and medial disconnectable coupling member 28. Medial disconnectable coupling member 28 is coupled to medial back portion 11.

Medial linking member 51 comprises first terminus 50 that is coupled to heel loop 73 by means of medial primary ankle anchor member 40, medial ankle crossover linkage segment 52 that extends between medial ankle coupling member 58 and lateral disconnectable coupling member 25, medial toe crossover linkage segment 64 and second terminus 65. Lateral disconnectable coupling member 25 is coupled to lateral back portion 6 of lateral edge 7 of base structure 4. Medial toe crossover linkage segment 64 extends between lateral disconnectable coupling member 25 and second terminus 65 that is coupled to medial front portion 14 of medial edge 10 by means of medial toe anchor member 70. Preferably, lateral disconnectable coupling member 25 is slidably attached to medial linking member 51.

Referring to FIG. 6, yet another preferred embodiment of interface system 1 is presented. In this embodiment, interface system 1 preferably includes rigid base structure 4, vertical support member 13, and two pliable linkage members: lateral linkage member 48 and medial linkage member 51.

Base structure 4 preferably comprises lateral edge 7, medial edge 10, and heel loop portion 73. Heel loop portion 73 is either adjustably connected to lateral edge 7 and to medial edge 10, or is a contiguous portion of lateral edge 7 and medial edge 10. Vertical support member 13 is preferably attached to heel loop portion 73 of base structure 4 and comprises bottom 15, a plurality of layers and calf pad 16. Lateral primary ankle anchor member 37 and medial primary ankle anchor member 40 are coupled to heel loop portion 73 or to vertical support member 13. Lateral ankle member first layer 79 is attached to lateral edge 7 and medial ankle member first layer that is attached to medial edge 10. Medial toe anchor member 70 is coupled to medial toe portion 14.

Medial linkage member 51 preferably comprises (1) first end 47 that is connected to the bottom of vertical support member 13 by means of lateral primary ankle member 37 that passes through (and is slidably attached to) lateral ankle coupling member 55, (2) heel linkage member 30 that passes behind the heel of the user and then passes through (and is slidably attached to) medial ankle coupling member 58, (3) ankle crossover linkage segment 50 that extends between medial ankle coupling member 58 and lateral disconnectable coupling member 25 that is coupled to lateral lateral back portion 6, (4) lateral toe crossover linkage segment 64 that extends from lateral disconnectable coupling member 25 to medial toe anchor member 70, and second terminus 65 that is connected to medial toe anchor member 70. Medial ankle padding member 94 is supported on medial ankle crossover linkage segment 52. Medial toe padding member 100 is supported on medial toe crossover linkage segment 64. Preferably, lateral disconnectable coupling member 25 is slidably attached to linkage segments 51 and 64.

Lateral linkage member 48 preferably comprises first terminus 50 that is coupled to lateral ankle coupling member 55, lateral ankle crossover linkage segment 49 that extends between lateral ankle coupling member 55 and medial disconnectable coupling member 28 that is coupled to medial back portion 11, and second terminus 65 that coupled to medial disconnectable coupling member 28. Lateral ankle padding member 91 is supported on lateral ankle crossover linkage segment 49.

In a preferred embodiment, vertical support member 13 comprises first layer 76 and second layer 77, first layer 76 being pliable and second layer 77 being rigid or semi-rigid and having a cutout or depression adjacent its base in the area of the user's Achilles tendon. Preferably, heel linkage member 30 passes between first layer 76 and second layer 77 of vertical support member 13. Preferably, heel linkage member 30 is threaded through openings in any one, two or all of the layers of vertical support member 13. Alternatively, heel linkage member 30 is fastened or bonded to any one, two or all of the layers of vertical support member 13.

Preferably, first layer 76 is a somewhat pliable member that is preferably made from linear low density polyethylene, or any other suitable material such as a woven fabric. First layer 76 interfaces directly with the back side of the boot (not shown), although it may have a padding layer adhered to it, between first layer 76 and the boot The purpose of first layer 76 is to provide a dynamically conformable support to the back side of the boot and to provide resistance to heel lift Passing heel linkage member 30 through one or more layers of vertical support member 13 has the purpose of pulling first layer 76 up to and around the back side of the boot (not shown) so that support of the boot is optimized. This is a more preferred aspect of the invention.

Second layer 77 of vertical support member 13 has cutout 103 provided in the area of the Achilles tendon of the user. Because of the pliable nature of first layer 76, the presence of cutout 103 in second layer 77 allows the boot to push first layer 76 back and effectively mold the boot's own shape into first layer 76 forming a pocket

First layer 76 may be incorporated into a preferred embodiment disclosed above or any system even though a heel linkage member is not present to pull first layer 76 against the back side of the boot Also, second layer 77 (containing cutout 103) may be the final supportive layer (i.e., of a two-layer system), or it may simply be an intermediate layer of a three (or more) layer system. Furthermore, cutout 103 in second layer 103 may be eliminated, in which case, the space required for first layer 76 to form its own custom pocket may be obtained by simply reducing the effective radius of first layer 76 so as to leave a small gap between first layer 76 and second layer 77.

In a three-layer system (not shown), an intermediate layer is introduced between first layer 76 and second layer 77. The intermediate layer may be made of a semi-rigid or rigid material such as plastic, carbon fiber, or aluminum, etc. and has the purpose of broadening the support area of vertical support member 13 up to the area of the calf muscle of the user, while still allowing for some flexibility during various maneuvers. Second layer 77 is the main supportive (and most rigid) layer providing the necessary resistance to movement of the boot, as is the case with a traditional high back.

It is preferred that a forward-lean-adjustment mechanism (not shown) be incorporated into interface system 1. This mechanism may be of a conventional design and interfaces with any or all layers of vertical support member 13 and/or heel loop 73, as with conventional strap bindings. The disconnectable entry/exit mechanisms described herein may alternatively be modified versions of the ladder strap and ratchet mechanisms that are used in current strap binding systems.

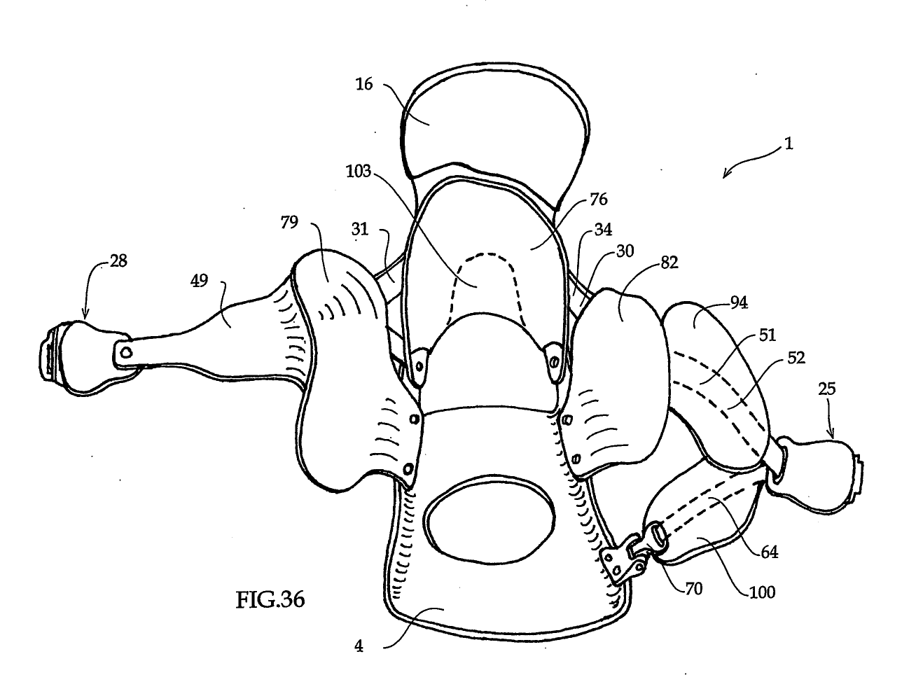

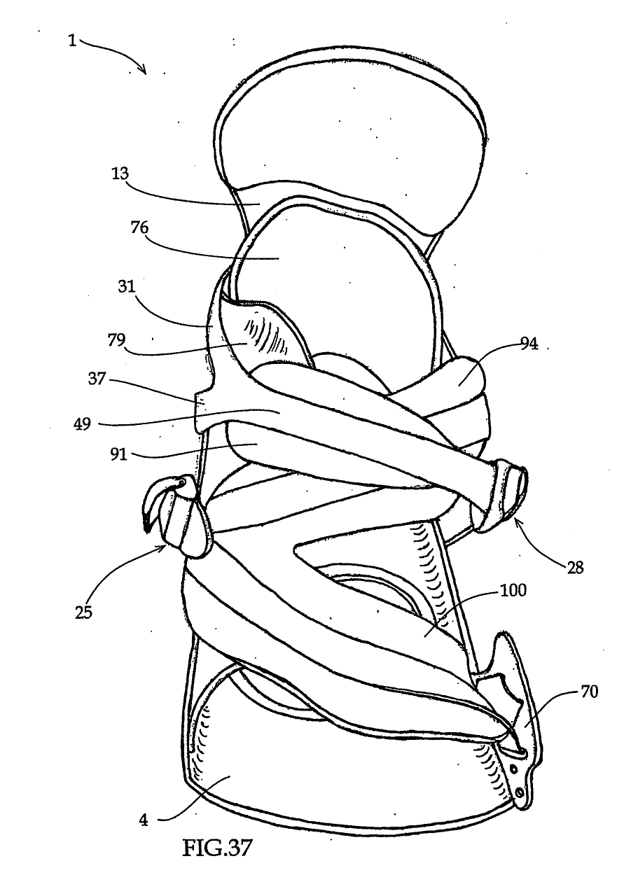

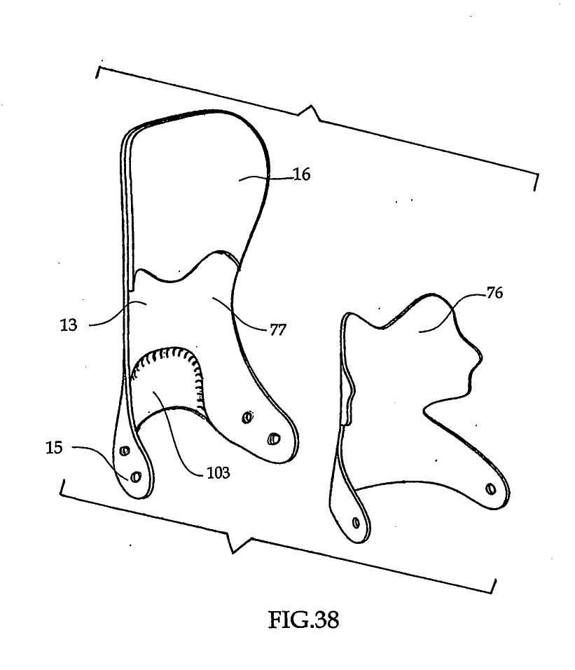

Additionally, member first layers 79, 82, 85, and 88 and/or padding members 91, 94, 97, and 100 may be incorporated into interface system 1, as shown in FIGS. 6 and 36. The purpose of these components is to distribute the pressure of the linkage members over a broader area of the boot Selected segments of the linkage members may be threaded through (or interface with, e.g., be bonded to) the edges to provide additional support in keeping the linkage members in place at all times. Such components are preferably made of a linear low density polyethylene, urethane, a woven fabric, or other suitable material Their construction and function are similar to that of the first layer 76 of vertical support member 13, and they may be incorporated into any of the preferred embodiments, or any other system.

FIGS. 7 through 33 present alternative component connection configurations in the vicinity of heel loop 73. Lateral connection configurations are illustrated but similar connection configurations could be used on the medial side of the device. Alternatively, any combination of two dissimilar configurations could be used laterally and medially. A person having ordinary skill in the art would realize which configurations are appropriate for each embodiment disclosed herein.

Referring to FIG. 7, a preferred configuration of component connections in the vicinity of heel loop 73 of a preferred embodiment of the invention is presented. In this embodiment, lateral disconnectable coupling mechanism base 19 is fastened (e.g., riveted or bolted) to lateral edge 7. Lateral primary ankle anchor member 37 is fastened (e.g., riveted or bolted) to the bottom of vertical support member 13 and is contiguous with lateral segment 31. Vertical support member 13 is separately fastened to heel loop 73.

The purpose of attaching lateral primary anchor coupling member 37 to vertical support member 13 at a location that is forward of the pivoting mounting location of vertical support member 13 is to provide resistance to “folding” of the high back when tension is applied to the linkage, e.g., when the user's heel is tending to lift up (as during a toe-side turn.) This “mechanism” further reduces heel lift and is believed by the applicant to be an improvement on the Burton method of providing a clasp device to lock the high back in a vertical position, because in the present invention no additional components are required and no input from the user is needed to “lock” the high back during a toe-side turn etc.

Lateral primary anchor coupling member 37 is attached to vertical support member 13 so that when tension is applied to linkage member 49, vertical support member 13 is maintained in an upright position. This is a desirable trait in a snowboard binding and may be incorporated into the first or third preferred embodiment disclosed herein. Preventing the vertical support member(s) from rotating (or folding down) during operation has been addressed by other companies (such as Burton) by incorporating a latching mechanism in the vertical support member, to latch the vertical support member to the heel loop during operation. The approach disclosed herein is believed by the applicant to be more desirable because it does not require an additional latching mechanism, nor does it require the user to lock and unlock any locking mechanism, thereby simplifying manufacture and operation of interface system 1.

Referring to FIG. 8, another preferred configuration of component connections in the vicinity of heel loop 73 of a preferred embodiment of the invention is presented. In this embodiment, lateral disconnectable coupling mechanism base 19 is fastened (e.g., riveted or bolted) to lateral edge 7. Vertical support member 13 and lateral primary ankle anchor member 37 are separately fastened (e.g., riveted or bolted) to heel loop 73.

Referring to FIG. 9, another preferred configuration of component connections in the vicinity of heel loop 73 of a preferred embodiment of the invention is presented. In this embodiment, lateral disconnectable coupling mechanism base 19 is fastened (e.g., riveted or bolted) to lateral edge 7. Vertical support member 13 and lateral primary ankle anchor member 37 are fastened (e.g., riveted or bolted) to heel loop 73 at a single location.

Referring to FIG. 10, another preferred configuration of component connections in the vicinity of heel loop 73 of a preferred embodiment of the invention is presented. In this embodiment, lateral secondary ankle anchor link 43 is fastened to lateral edge 7 forward of the location that lateral disconnectable coupling mechanism base 19 is fastened to lateral edge 7. In alternative embodiments of the configurations presented in FIGS. 10-33, lateral secondary ankle anchor link 43 is fastened to lateral edge 7 behind the location that lateral disconnectable coupling mechanism base 19 is fastened to lateral edge 7. In this embodiment, both lateral secondary ankle anchor link 43 and lateral primary ankle anchor member are fastened to lateral ankle coupling member 55. Lateral primary ankle anchor member 37 is fastened to the bottom of vertical support member 13.

Referring to FIG. 11, another preferred configuration of component connections in the vicinity of heel loop 73 of a preferred embodiment of the invention is presented. In this embodiment, lateral primary ankle anchor member 37 is fastened to the bottom of vertical support member 13 and to lateral ankle coupling member 55.

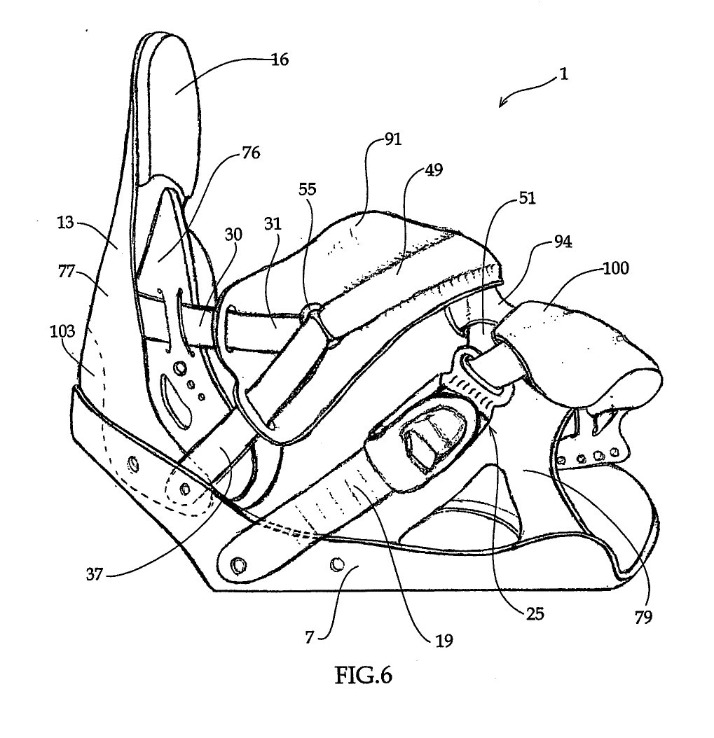

Referring to FIG. 12, another preferred configuration of component connections in the vicinity of heel loop 73 of a preferred embodiment of the invention is presented. In this embodiment, lateral secondary ankle anchor link 43 is fastened to lateral edge 7 forward of the location that lateral disconnectable coupling mechanism base 19 is fastened to lateral edge 7. Both lateral secondary ankle anchor link 43 and lateral primary ankle anchor member 37 are fastened to lateral ankle coupling member 55 and, in this embodiment, lateral primary ankle anchor member 37 and lateral ankle coupling member 55 are integral (one piece). Lateral primary ankle anchor member 37 is fastened to the bottom of vertical support member 13.

Referring to FIG. 13, another preferred configuration of component connections in the vicinity of heel loop 73 of a preferred embodiment of the invention is presented. In this embodiment, lateral secondary ankle anchor link 43 is fastened to lateral edge 7 forward of the location that lateral disconnectable coupling mechanism base 19 is fastened to lateral edge 7. Both lateral secondary ankle anchor link 43 and lateral primary ankle anchor member 37 are fastened to lateral ankle coupling member 55 and, in this embodiment, lateral secondary ankle anchor member 43 and lateral ankle coupling member 55 are integral (one piece). Lateral primary ankle anchor member 37 is fastened to the bottom of vertical support member 13.

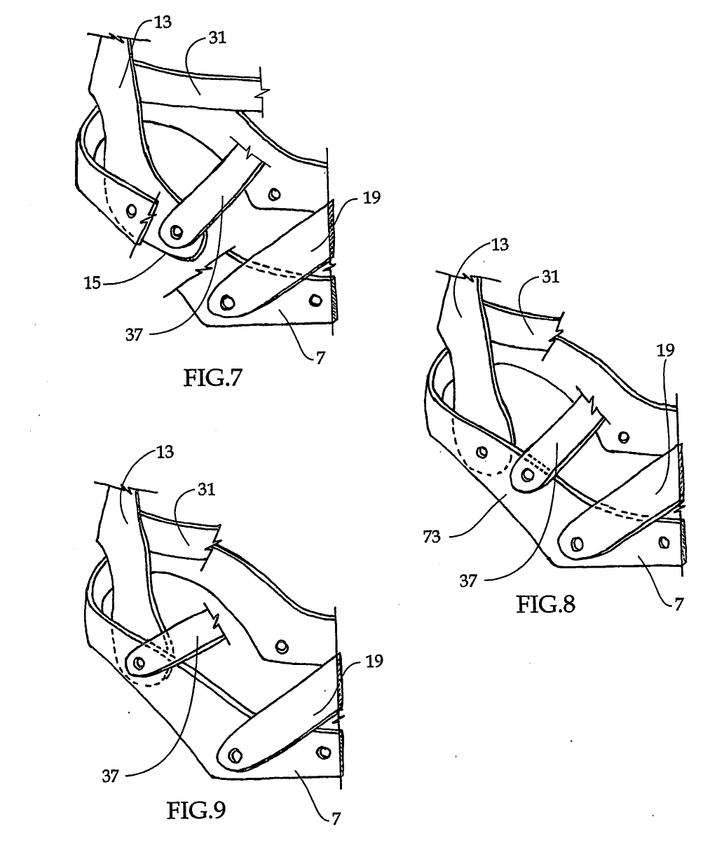

Referring to FIG. 14, another preferred configuration of component connections in the vicinity of heel loop 73 of a preferred embodiment of the invention is presented. In this embodiment, lateral primary ankle anchor member 37 is fastened to the bottom of vertical support member 13 and to lateral ankle coupling member 55. Lateral primary ankle anchor member 37 is integral with lateral ankle coupling member 55.

Referring to FIG. 15, another preferred configuration of component connections in the vicinity of heel loop 73 of a preferred embodiment of the invention is presented. In this embodiment, lateral secondary ankle anchor link 43 is fastened to lateral edge 7 forward of the location that lateral disconnectable coupling mechanism base 19 is fastened to lateral edge 7. Both lateral secondary ankle anchor link 43 and lateral primary ankle anchor member 37 are fastened to lateral ankle coupling member 55 and, in this embodiment, both lateral primary ankle anchor member 37 and lateral secondary ankle anchor member 43 are integral with lateral ankle coupling member 55. Lateral primary ankle anchor member 37 is fastened to the bottom of vertical support member 13.

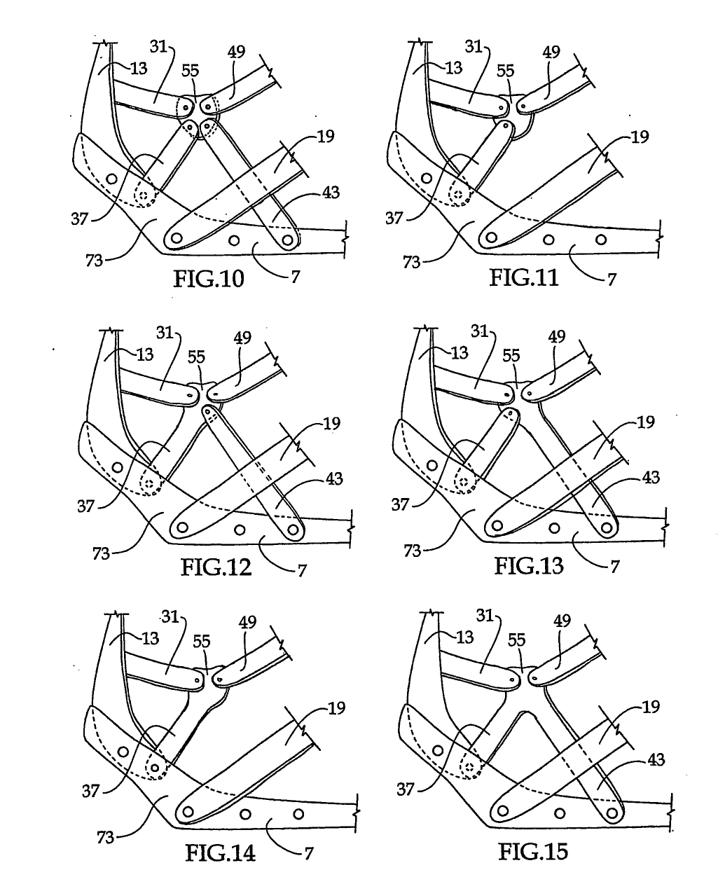

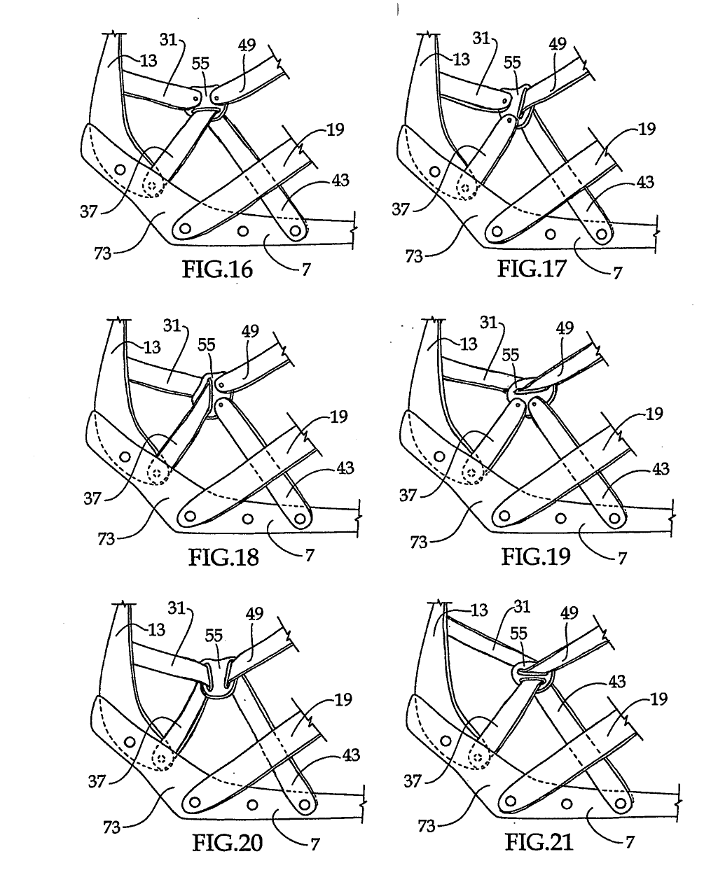

Referring to FIG. 16, another preferred configuration of component connections in the vicinity of heel loop 73 of a preferred embodiment of the invention is presented. In this embodiment, lateral secondary ankle anchor link 43 is fastened to lateral edge 7 forward of the location that lateral disconnectable coupling mechanism base 19 is fastened to lateral edge 7. Lateral secondary ankle anchor link 43 and lateral primary ankle anchor member are integral and pass through a slot in (are slidably coupled with) lateral ankle coupling member 55. Lateral primary ankle anchor member 37 is fastened to the bottom of vertical support member 13. FIGS. 16-18 illustrate similar configurations, being essentially rotated versions of one another. In each, lateral ankle coupling member 55 has one attachment slot and two other attachment points (e.g., bolt holes).

Referring to FIG. 17, another preferred configuration of component connections in the vicinity of heel loop 73 of a preferred embodiment of the invention is presented. In this embodiment, lateral secondary ankle anchor link 43 is fastened to lateral edge 7 forward of the location that lateral disconnectable coupling mechanism base 19 is fastened to lateral edge 7. Lateral secondary ankle anchor link 43 and lateral ankle crossover linkage segment 49 are integral and pass through a slot in (are slidably coupled with) lateral ankle coupling member 55. Lateral primary ankle anchor member 37 is fastened to the bottom of vertical support member 13.

Referring to FIG. 18, another preferred configuration of component connections in the vicinity of heel loop 73 of a preferred embodiment of the invention is presented. In this embodiment, lateral secondary ankle anchor link 43 is fastened to lateral edge 7 forward of the location that lateral disconnectable coupling mechanism base 19 is fastened to lateral edge 7. Lateral primary ankle anchor link 37 and lateral heel linkage member segment 31 are integral and pass through a slot in (are slidably coupled with) lateral ankle coupling member 55. Lateral primary ankle anchor member 37 is fastened to the bottom of vertical support member 13.

Referring to FIG. 19, another preferred configuration of component connections in the vicinity of heel loop 73 of a preferred embodiment of the invention is presented. In this embodiment, lateral secondary ankle anchor link 43 is fastened to lateral edge 7 forward of the location that lateral disconnectable coupling mechanism base 19 is fastened to lateral edge 7. Lateral secondary ankle anchor link 43 and lateral ankle crossover linkage segment 49 are integral and pass through a slot in (are slidably coupled with) lateral ankle coupling member 55. Lateral primary ankle anchor member 37 is fastened to the bottom of vertical support member 13.

Referring to FIG. 20, another preferred configuration of component connections in the vicinity of heel loop 73 of a preferred embodiment of the invention is presented. In this embodiment, lateral secondary ankle anchor link 43 is fastened to lateral edge 7 forward of the location that lateral disconnectable coupling mechanism base 19 is fastened to lateral edge 7. Lateral secondary ankle anchor link 43 and lateral ankle crossover linkage segment 49 are integral and pass through a first slot in lateral ankle coupling member 55. Lateral secondary ankle anchor link 43 and lateral heel linkage member segment 31 are integral and pass through a second slot in lateral ankle coupling member 55. Lateral primary ankle anchor member 37 is fastened to the bottom of vertical support member 13.

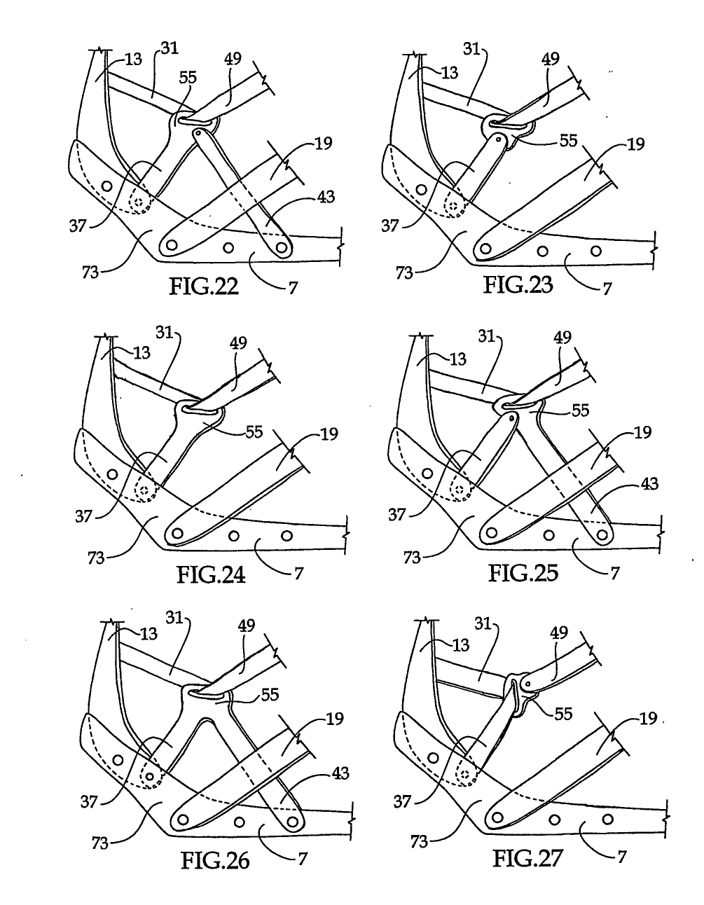

Referring to FIG. 21, another preferred configuration of component connections in the vicinity of heel loop 73 of a preferred embodiment of the invention is presented. In this embodiment, lateral secondary ankle anchor link 43 is fastened to lateral edge 7 forward of the location that lateral disconnectable coupling mechanism base 19 is fastened to lateral edge 7. Lateral secondary ankle anchor link 43 and lateral primary ankle anchor member are integral and pass through a first slot in lateral ankle coupling member 55. Lateral secondary ankle anchor link 43 and lateral ankle crossover linkage segment 49 are integral and pass through a second slot in lateral ankle coupling member 55. Lateral primary ankle anchor member 37 is fastened to the bottom of vertical support member 13.

Referring to FIG. 22, another preferred configuration of component connections in the vicinity of heel loop 73 of a preferred embodiment of the invention is presented. In this embodiment, lateral secondary ankle anchor link 43 is fastened to lateral edge 7 forward of the location that lateral disconnectable coupling mechanism base 19 is fastened to lateral edge 7. Lateral secondary ankle anchor link 43 and lateral ankle crossover linkage segment 49 are integral and pass through a slot in lateral ankle coupling member 55. Lateral primary ankle anchor member 37 is integral with lateral ankle coupling member 55 and is fastened to the bottom of vertical support member 13.

Referring to FIG. 23, another preferred configuration of component connections in the vicinity of heel loop 73 of a preferred embodiment of the invention is presented. In this embodiment, that lateral disconnectable coupling mechanism base 19 is fastened to lateral edge 7. Lateral heel linkage member segment 31 and lateral ankle crossover linkage segment 49 are integral and pass through a slot in lateral ankle coupling member 55. Lateral primary ankle anchor member 37 is fastened to the bottom of vertical support member 13.

Referring to FIG. 24, another preferred configuration or component connections in the vicinity of heel loop 73 of a preferred embodiment of the invention is presented. In this embodiment, lateral disconnectable coupling mechanism base 19 is fastened to lateral edge 7. Lateral heel linkage member segment 31 and lateral ankle crossover linkage segment 49 are integral and pass through a slot in lateral ankle coupling member 55. Lateral primary ankle anchor member 37 is integral with lateral ankle coupling member 55 and is fastened to the bottom of vertical support member 13.

Referring to FIG. 25, another preferred configuration of component connections in the vicinity of heel loop 73 of a preferred embodiment of the invention is presented. In this embodiment, lateral secondary ankle anchor link 43 is fastened to lateral edge 7 forward of the location that lateral disconnectable coupling mechanism base 19 is fastened to lateral edge 7. Lateral heel linkage member segment 31 and lateral ankle crossover linkage segment 49 are integral and pass through a slot in lateral ankle coupling member 55. Lateral secondary ankle anchor member 43 is integral with lateral ankle coupling member 55 and is fastened to the bottom of vertical support member 13.

Referring to FIG. 26, another preferred configuration of component connections in the vicinity of heel loop 73 of a preferred embodiment of the invention is presented. In this embodiment, lateral secondary ankle anchor link 43 is fastened to lateral edge 7 forward of the location that lateral disconnectable coupling mechanism base 19 is fastened to lateral edge 7. Lateral heel linkage member segment 31 and lateral ankle crossover linkage segment 49 are integral and pass through a slot in lateral ankle coupling member 55. Lateral primary ankle anchor member 37 and lateral secondary ankle anchor member 43 are integral with lateral ankle coupling member 55.

Referring to FIG. 27, another preferred configuration of component connections in the vicinity of heel loop 73 of a preferred embodiment of the invention is presented. In this embodiment, lateral disconnectable coupling mechanism base 19 is fastened to lateral edge 7. Lateral primary ankle anchor link 37 and lateral heel linkage member segment 31 are integral and pass through a slot in lateral ankle coupling member 55. Lateral primary ankle anchor member 37 is fastened to the bottom of vertical support member 13.

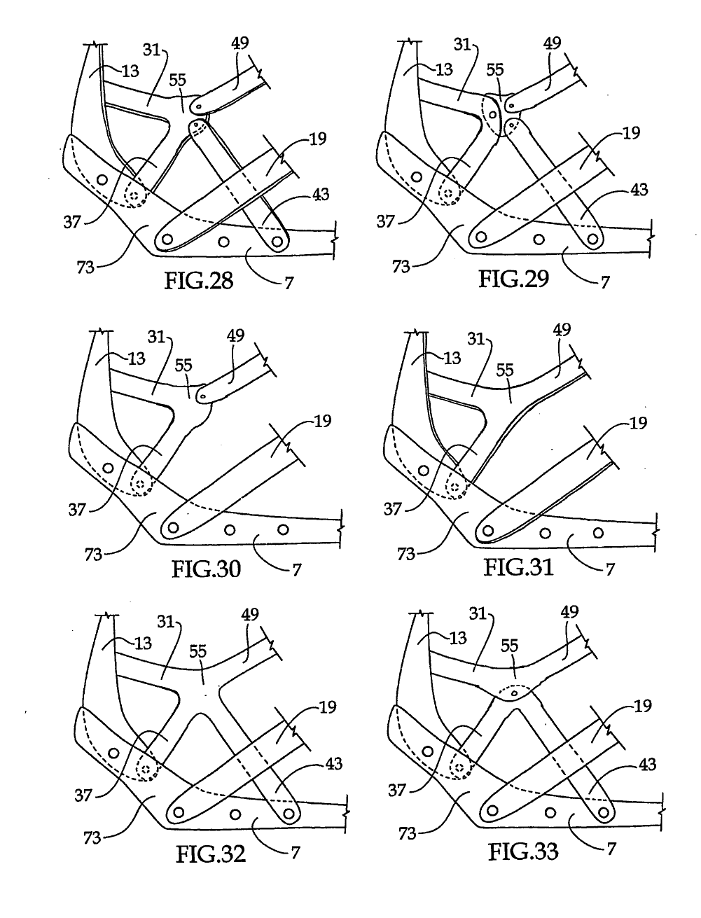

Referring to FIG. 28, another preferred configuration of component connections in the vicinity of heel loop 73 of a preferred embodiment of the invention is presented. In this embodiment, lateral secondary ankle anchor link 43 is fastened to lateral edge 7 forward of the location that lateral disconnectable coupling mechanism base 19 is fastened to lateral edge 7. Lateral heel linkage member segment 31 and lateral primary ankle anchor link 37 are integral with lateral ankle coupling member 55.

Referring to FIG. 29, another preferred configuration of component connections in the vicinity of heel loop 73 of a preferred embodiment of the invention is presented. In this embodiment, lateral secondary ankle anchor link 43 is fastened to lateral edge 7 forward of the location that lateral disconnectable coupling mechanism base 19 is fastened to lateral edge 7. Lateral heel linkage member segment 31 and lateral primary ankle anchor link 37 are integral and are fastened to lateral ankle coupling member 55.

Referring to FIG. 30, another preferred configuration of component connections in the vicinity of heel loop 73 of a preferred embodiment of the invention is presented. In this embodiment, lateral disconnectable coupling mechanism base 19 is fastened to lateral edge 7. Lateral heel linkage member segment 31 and lateral primary ankle anchor link 37 are integral with lateral ankle coupling member 55.

Referring to FIG. 31, another preferred configuration of component connections in the vicinity of heel loop 73 of a preferred embodiment of the invention is presented. In this embodiment, lateral secondary ankle anchor link 43 is fastened to lateral edge 7 forward of the location that lateral disconnectable coupling mechanism base 19 is fastened to lateral edge 7. Lateral heel linkage member segment 31, lateral primary ankle anchor link 37 and lateral ankle crossover linkage segment 49 are integral with lateral ankle coupling member 55.

Referring to FIG. 32, another preferred configuration of component connections in the vicinity of heel loop 73 of a preferred embodiment of the invention is presented. In this embodiment, lateral secondary ankle anchor link 43 is fastened to lateral edge 7 forward of the location that lateral disconnectable coupling mechanism base 19 is fastened to lateral edge 7. Lateral heel linkage member segment 31, lateral ankle crossover linkage segment 49, lateral primary ankle anchor link 37 and lateral secondary ankle anchor link 43 are integral with lateral ankle coupling member 55.

Referring to FIG. 33, another preferred configuration of component connections in the vicinity of heel loop 73 of a preferred embodiment of the invention is presented. In this embodiment, lateral secondary ankle anchor link 43 is fastened to lateral edge 7 forward of the location that lateral disconnectable coupling mechanism base 19 is fastened to lateral edge 7. Lateral heel linkage member segment 31 and lateral ankle crossover linkage segment 49 are integral with lateral ankle coupling member 55. Lateral primary ankle anchor link 37 and lateral secondary ankle anchor link 43 are integral.

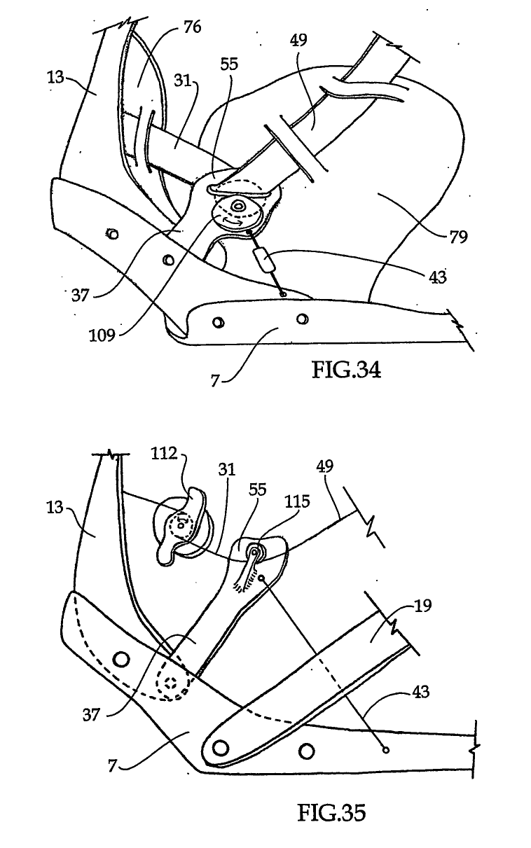

Referring to FIG. 34, locking component 109 is shown mounted on lateral ankle coupling member 55. The purpose of locking component 109 is to lock the position of the linkage member (here lateral heel linkage segment 31 and lateral ankle crossover linkage segment 49) so that it/they cannot slide through the slot in lateral ankle coupling member coupling 55 after the linkage members have been adjusted to the user's foot This improvement only pertains to the configurations in which the linkage member passes through coupling 55 (e.g., when heel segment 31 and ankle crossover segment 49 are continuous, or involve the application of pulleys) and not to the configuration in which the linkage member is simply attached to coupling 55 (e.g., by bolting, riveting or sewing). The reason for this is so that the lateral linkage member 48 or medial linkage member 51 can be tightened down when the other linkage member is not engaged (the associated disconnectable coupling member is disconnected) and the disengaged linkage member will not simply pull through the ankle coupling member. This allows for the rider to operate the system with only one of either the lateral linkage member 48 or medial linkage member 48 engaged, which is desirable in a temporary situation such as getting from one lift to another.

Referring to FIG. 35, tensioning knob 112 is shown intersecting lateral heel linkage member segment 31 and/or medial heel linkage member segment 34 for the purpose of applying additional tension to the heel linkage member 30. Tensioning knob 112 may be mounted on either vertical support member 13 or to heel member first layer 76. The construction of knob 112 is not important, as long as it can be used to increase, release, and lock the tension in heel linkage member 30.

Referring to FIG. 36, a preferred embodiment of interface system 1 is shown in the open position. The routing of the linkage members in this embodiment is essentially the same as that illustrated in FIG. 3. In this embodiment, lateral ankle member first layer 79 is attached to lateral edge 7. Similarly, medial ankle member first layer 82 is attached to medial edge 10. Medial ankle padding member 94 is supported on medial ankle crossover linkage segment 52 and medial toe padding member 100 is supported on medial toe crossover linkage segment 64. The ankle member first layers and padding members shown in FIG. 36 can be used in any of the embodiments disclosed herein. While a lateral toe padding member is not shown in FIG. 36, one could be incorporated into the embodiments of FIGS. 1 and 4. Similarly, alternative embodiments incorporate a lateral toe member first layer (not shown) and/or a medial toe member first layer (not shown) that are similar in concept to lateral ankle member first layer 79 and medial ankle member first layer 82.

Referring to FIG. 37, a top/front view of a preferred embodiment of interface system 1 in the dosed position is presented. The routing of the linkage members in this embodiment is essentially the same as that illustrated in FIG. 3. The general configuration of the ankle crossover linkage segments, lateral ankle coupling members and primary ankle anchor members is that illustrated in FIG. 31. Lateral disconnectable coupling member 25 is shown buckled to lateral edge 7 and medial disconnectable coupling member 28 is shown buckled to medial edge 10.

Referring to FIG. 38, an exploded view of the vertical support member and its first layer is presented. In this view, cut-out or depression 103 in heel member second layer 77 of vertical support member 13 is shown and the gap between the first layer 76 and second layer 77 of vertical support member 13 is illustrated. Second layer 77 of vertical support member 13 has cutout 103 in the area of the Achilles tendon of the user. Because of the pliable nature of first layer 76, the presence of cutout 103 in second layer 77 allows the boot to push first layer 76 back and effectively mold the boot's shape into layer 76, forming a pocket in first layer 76. This pocket is traditionally known as “the heel pocket of a high back” and is usually permanently molded into the high back, in what is believed to be an optimal generic shape. An advantage of preferred embodiments of the present invention is that the presence of cutout 103 allows the shape of the heel pocket to be dynamically defined by the position and form of the boot that is then occupying it This dynamic conformability is believed by the applicant to create a far superior interface to the complex variety of boot shapes as well as positions and movements of the boot during riding.

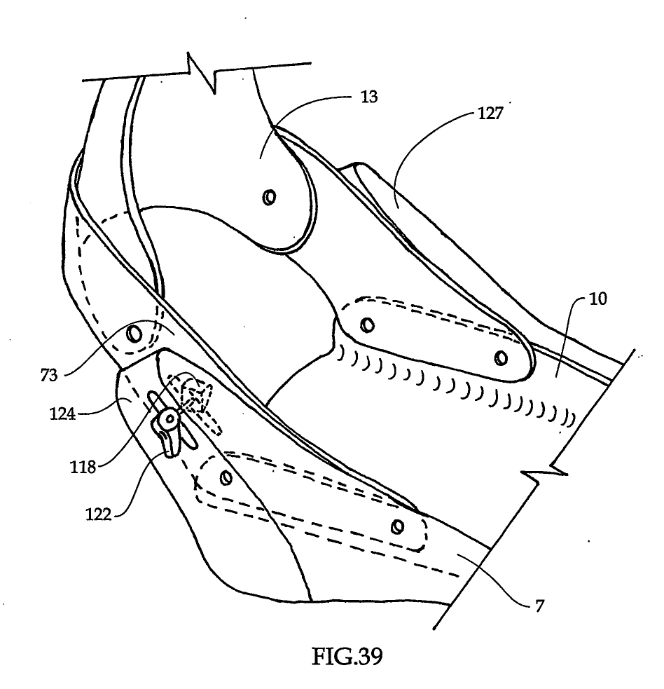

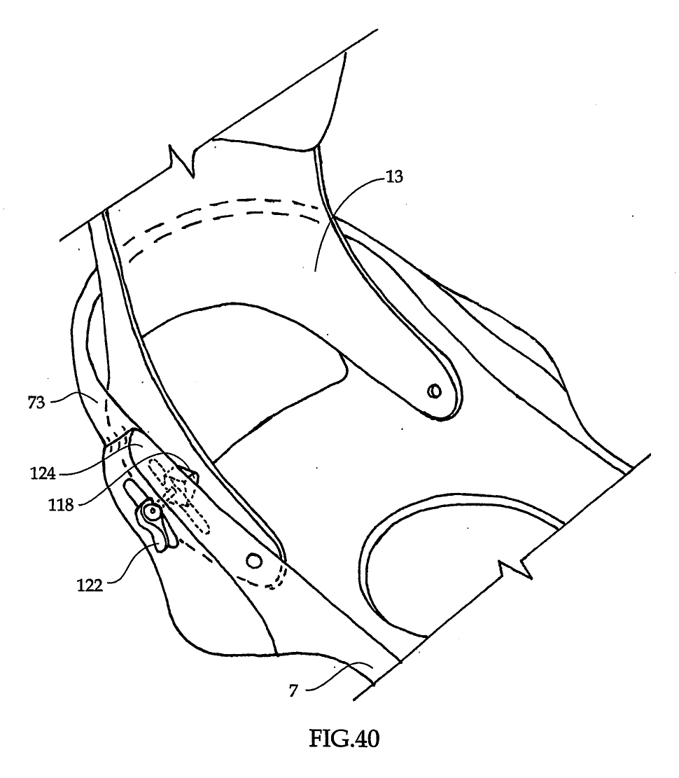

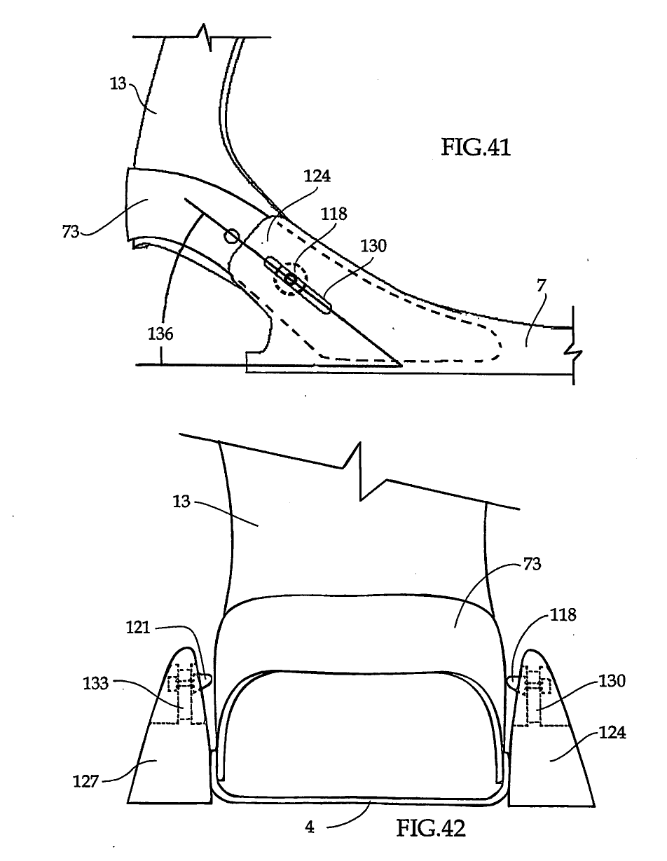

Referring to FIG. 39, a perspective view of flex bumper 118 is presented. In this embodiment (in which heel loop 73 and base structure 4 are separate pieces), the bumper support member is mounted (e.g., bolted) on or part of base structure 4 and the bumper interferes with the outside surface of heel loop 73, or with the outside surface of vertical support member 13, through an opening in heel loop 73.

Flex bumper 118 gives the user the ability to adjust the lateral/medial flex of the heel loop and/or vertical support member (high back). This is accomplished by positioning a flex bumper component on either side of heel loop portion 73 of base structure 4 or vertical support member 13. The flex bumper component is positioned (e.g., moved up and down or in and out) so as to interfere with, and thus limit the flex of heel loop 73 or vertical support member 13 when either of those components is flexed in the lateral or medial direction during various snowboarding maneuvers. Preferably, each bumper component is adjustably mounted on one of the rigid support members 124 and 127. Support members 124 and 127 may be mounted on base structure 4 or alternatively, be a part of base structure 4. This rigid support member is preferably located in the general area of the side of the heel loop portion of the base structure approximately following profile of the heel loop surface and being substantially widened away from the bas structure. The support member has an inside surface which is angled away from the heel loop portion so as to allow unrestricted flex of the heel loop and vertical support member.

Preferably, the bumper component is mounted so as to protrude past this surface, towards the outer surface of heel loop 73 or vertical support member 13, at a distance which is adjustable, and, therefore, allows different limits on the flex of heel loop 73 and/or vertical support member 13. It is further preferred that bumper component 118 be mounted in a slot in rigid support member 124 so that it may be positioned to interfere with different locations on the outside surface or heel loop portion 73 of base structure 4 or vertical support member 13. This allows even greater customization of the flex patterns and limits of motion of heel loop 73 and/or vertical support member 73.

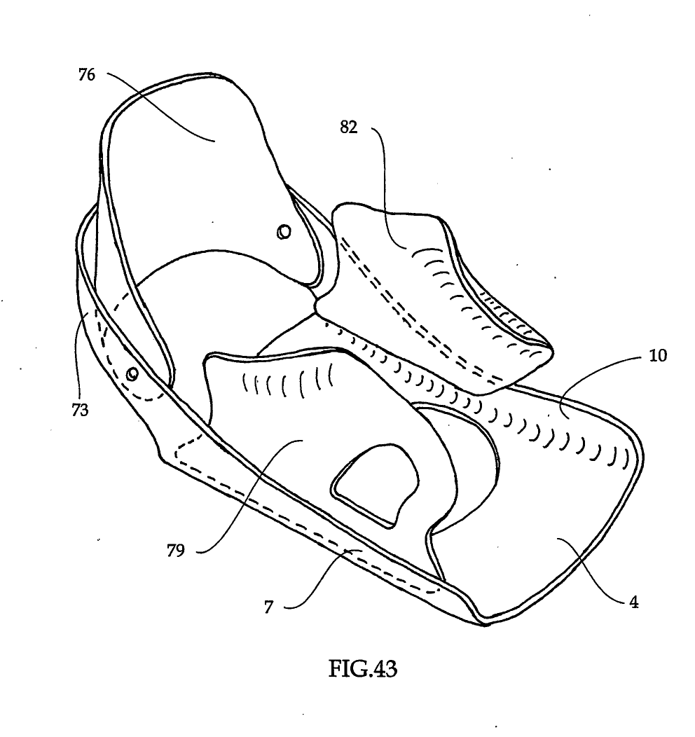

Referring to FIG. 40, a perspective view of the first flex bumper 118 is presented. The rigid support member (first flex bumper support member 124) is also shown. In this embodiment (in which heel loop 73 and base structure 4 are one piece), bumper support member 124 is mounted on, or part of base structure 4 and bumper 118 interferes with the outside surface of vertical support member 13. Operation of bumper release lever 122 allows the repositioning of bumper 118. This embodiment could easily be incorporated into conventional snowboard bindings and other interface systems.

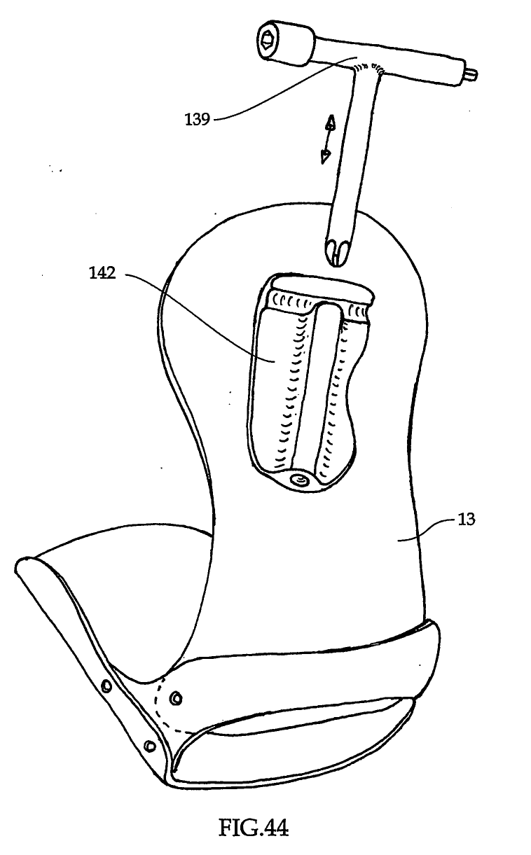

Referring to FIG. 41, a side view of the adaptive base structure 4 and flex bumper mounting slot 130 are presented flex bumper slot is disposed at angle 136 (approximately 35 degrees) with respect to base 4. In this view, a possible adjustment method (e.g., sliding in first slot 130) for flex bumper 118 in relation to its associated rigid support members 124 is illustrated. In FIG. 42, a back view of the adaptive base structure 4 of this embodiment of the invention is presented showing first slot 130 in bumper support member 124 and second slot 133 in second bumper support member 127. In this embodiment, flex bumpers 118 and 121 are interfering with the movement of heel loop portion 73.

Referring to FIG. 43, the three principle components of the first layer (heel member first layer 76, lateral ankle member first layer 79 and medial ankle member first layer 82) of a preferred embodiment of the interface system are presented. Many components have been omitted from this view for clarity. Lateral ankle member first layer 79 and medial ankle member first layer 82 are connected to their respective edges 7 and 10 and heel member first layer 76 is connected either to heel loop 73 or to vertical support member 13. These three components could be advantageously used regardless of the selected strap configuration, even with traditional straps in which case there may be two additional first layer components associated with the toe strap. The components are beneficial in any system because they distribute the pressure of the straps over a very broad area of the foot, allowing the actual linkages to be less bulky (e.g., very thin) and eliminate the need for broadening the areas of the linkages that cross over the top of the foot as is the case with all traditional straps. The components could be produced in molds that are more specific to a particular boot geometry, eliminating the need to re-tool the entire strap. They are preferably made of a material that can be heat formed or stress formed to conform to the user's boot Preferred materials are thermoplastics (LLDPE, etc.), urethane and woven fabric.

Referring to FIG. 44, multi-tool 139 is shown mounted on vertical support member 13 in mounting sheath 142. Multi-tool 139 is used for adjusting system fasteners. Preferably, the functional ends of the multi-tool 139 are any combination of Philips head, hex head, allen head, or any other fastener type that may be used on a snowboard binding. The tool is compromised of two sections: the first being the handle section and the second being the generally perpendicular shaft section. Mounting sheath 142 may be attached to any suitable vertical support member or high back, including other than those disclosed herein. Mounting sheath 142 may also be an integral part of vertical support member 13. Any conventional method may be used to secure multi-tool 139 in sheath 142. Benefits include easy access to the tool and relative safety.

### INDUSTRIAL APPLICABILITY

It is contemplated that the invention disclosed herein can be used for retaining a foot or a boot on a sports article. In particular, the invention can be used for retaining a human foot/ankle (either bare or covered) on a snowboard, snowshoe, wakeboard, inline skate or other sports article. The system may also be used as an internal or external support structure for a boot or other footwear.

Many variations of the invention will occur to those skilled in the art Some variations include a single linkage member. For example, such a single linkage member could be stamped out of a sheet of plastic. Other variations call for two linkage members. Additionally, any combination of the described linkage members may be subdivided into multiple components, or integrated into homogeneous components, while still retaining their original routing configurations. All such variations are intended to be within the scope and spirit of the invention

What is claimed is:

1.-60. (canceled)

61. An interface system for retaining a foot or a boot on a sports article for a user, the interface system comprising:
a base structure having a first edge having a first front portion and a first back portion, a second edge having a second front portion and a second back portion, and a heel loop connected to the first edge and the second edge;
a vertical support member that is attached to the heel loop; and
means for linking, the means for linking selected from the group consisting of:
a first linkage assembly comprising: a first linking member having two ends and a center, one of the ends being fastened to the vertical support member, the heel loop or to the first back portion, the other of the ends being fastened to the first front portion and the center being releasably connected to the second back portion, a second linking member having two endings and a middle, one of the endings being fastened to the vertical support member, the heel loop or to the second back portion, the other of the endings being fastened to the second front portion and the middle being releasably connected to the first back portion, and a third linking member extending from said one of the ends to said one of the endings;
a second linkage assembly comprising: a first linking member having two ends and a center, one of the ends being fastened to the vertical support member, the heel loop or to the first back portion, the other of the ends being releasably connected to the second back portion, a second linking member having two endings and a middle, one of the endings being fastened to the vertical support member, the heel loop or to the second back portion, the other of the endings being fastened to the second front portion and the middle being releasably connected to the first back portion, and a third linking member extending from said one of the ends to said one of the endings;
a third linkage assembly comprising: a first linking member having two ends and a center, one of the ends being fastened to the vertical support member, the heel loop or to the first back portion, the other of the ends being fastened to the first front portion and the center being releasably connected to the second back portion, and a second linking member having two endings and a middle, one of the endings being fastened to the vertical support member, the heel loop or to the second back portion, the other of the endings being fastened to the second front portion and the middle being releasably connected to the first heel portion;
a fourth linkage assembly comprising: a first linking member having two ends and a center, one of the ends being fastened to the vertical support member, to the heel loop or to the first back portion, the other of the ends being releasably connected to the second back portion, and a second linking member having two endings and a middle, one of the endings being fastened to the vertical support member, the heel loop or to the second back portion, the other of the endings being fastened to the second toe portion and the middle being releasably connected to the first back portion;
a fifth linkage assembly comprising: a first ankle coupling member that is coupled to the vertical support member, to the heel loop or to the first back portion, a second ankle coupling member that is coupled to the vertical support member, to the heel loop or to the first back portion, a first disconnectable coupling member that is coupled to the first back portion, a second disconnectable coupling member that is coupled to the second back portion, a first toe anchor member that is coupled to the second front portion, a first linking member having a first segment end that is connected to the vertical support member, to the heel loop or to the first back portion, a first primary ankle anchor segment that passes through the first ankle coupling member, a heel linkage segment that passes behind the heel of the user and then passes through the second ankle coupling member, a first ankle crossover linkage segment that extends between the second ankle coupling member and the first disconnectable coupling member, and a first toe crossover linkage segment that extends from the first disconnectable coupling member to the second toe anchor member and a second segment end that is connected to the first toe anchor member, said ends and segments being contiguous in the order described, and a second linking member having a first terminus that is coupled to the first ankle coupling member, a second ankle crossover linkage segment that extends between the second ankle coupling member and the second disconnectable coupling member, and a second terminus that is coupled to the second disconnectable coupling member, said termini and segments being contiguous in the order described; and
a sixth linkage assembly comprising: a first anchor coupling member that is fastened to the vertical support member, the heel loop or the first back portion, a second anchor coupling member that is fastened to the vertical support member, the heel loop or the second back portion, and a single linking member having a first termination that is attached to the second front portion, a first segment that is releasably connected to the first back portion, a second segment that is fastened to the second anchor coupling member, a third segment that extends between the second anchor coupling member to the first anchor coupling member and a second termination that is releasably connected to the second back portion, said terminations and segments being contiguous in the order described.

62. An interface system for retaining a foot or a boot on a sports article for a user, the interface system comprising:
a base structure having a first edge having a first front portion and a first back portion, a second edge having a second front portion and a second back portion, and a heel loop connected to the first edge and the second edge;
a vertical support member that is attached to the heel loop; and
means for linking, the means for linking selected from the group consisting of:
a first linkage assembly comprising: a first linking member having two ends and a center, one of the ends being fastened to the vertical support member, the heel loop or to the first back portion, the other of the ends being fastened to the first front portion and the center being releasably connected to the second back portion, a second linking member having two endings and a middle, one of the endings being fastened to the vertical support member, the heel loop or to the second back portion, the other of the endings being fastened to the second front portion and the middle being releasably connected to the first back portion, and a third linking member extending from said one of the ends to said one of the endings;
a second linkage assembly comprising: a first linking member having two ends and a center, one of the ends being fastened to the vertical support member, the heel loop or to the first back portion, the other of the ends being releasably connected to the second back portion, a second linking member having two endings and a middle, one of the endings being fastened to the vertical support member, the heel loop or to the second back portion, the other of the endings being fastened to the second front portion and the middle being releasably connected to the first back portion, and a third linking member extending from said one of the ends to said one of the endings;
a third linkage assembly comprising: a first linking member having two ends and a center, one of the ends being fastened to the vertical support member, the heel loop or to the first back portion, the other of the ends being fastened to the first front portion and the center being releasably connected to the second back portion, and a second linking member having two endings and a middle, one of the endings being fastened to the vertical support member, the heel loop or to the second back portion, the other of the endings being fastened to the second front portion and the middle being releasably connected to the first heel portion;
a fourth linkage assembly comprising: a first linking member having two ends and a center, one of the ends being fastened to the vertical support member, to the heel loop or to the first back portion, the other of the ends being releasably connected to the second back portion and a second linking member having two endings and a middle, one of the endings being fastened to the vertical support member, the heel loop or to the second back portion, the other of the endings being fastened to the second toe portion and the middle being releasably connected to the first back portion; and
a fifth linkage assembly comprising: a first ankle coupling member that is coupled to the vertical support member, to the heel loop or to the first back portion, a second ankle coupling member that is coupled to the vertical support member, to the heel loop or to the first back portion, a first disconnectable coupling member that is coupled to the first back portion, a second disconnectable coupling member that is coupled to the second back portion, a first toe anchor member that is coupled to the second front portion, a first linking member having a first segment end that is connected to the vertical support member, to the heel loop or to the first back portion, a first primary ankle anchor segment that passes through the first ankle coupling member, a heel linkage segment that passes behind the heel of the user and then passes through the second ankle coupling member, a first ankle crossover linkage segment that extends between the second ankle coupling member and the first disconnectable coupling member, and a first toe crossover linkage segment that extends from the first disconnectable coupling member to the second toe anchor member and a second segment end that is connected to the first toe anchor member, said ends and segments being contiguous in the order described, and a second linking member having a first terminus that is coupled to the first ankle coupling member, a second ankle crossover linkage segment that extends between the second ankle coupling member and the second disconnectable coupling member, and a second terminus that coupled to the second disconnectable coupling member, said termini and segments being contiguous in the order described.

63. The interface system of claim 62 further comprising:
a first ankle member first layer that is attached to the first edge or to the heel loop; and
a second ankle member first layer that is attached to the second edge or to the heel loop.

64. The interface system of claim 62 further comprising:
a first ankle padding member that is supported one of the linkage segments; and
a first toe padding member that is supported on another of the linkage segments.

65. The interface system of claim 62 further comprising:
a first bumper support member that is disposed adjacent to or integral with said first edge;
a second bumper support member that is disposed adjacent to or integral with said second edge;
a first bumper component mounted on said first bumper support, said first bumper component being operative to adjustably limit the movement in a first direction of the heel loop and/or the vertical support member; and
a second bumper component mounted on said second bumper support, said second bumper component being operative to adjustably limit the movement in a second direction of the heel loop and/or the vertical support member.

66. An interface system for retaining a foot or a boot of a user on a sports article, the interface system comprising:
a base structure having a first edge having a first front portion and a first back portion, a second edge having a second front portion and a second back portion, and a heel loop connected to the first edge and the second edge;
a vertical support member that is attached to the heel loop; and
means for linking the first edge and the second edge that is operative to secure the foot or boot in the interface system;
said system further comprising:
a first bumper support member that is disposed adjacent to or integral with said first edge;
a second bumper support member that is disposed adjacent to or integral with said second edge;
a first bumper component mounted on said first bumper support, said first bumper component being operative to limit the movement in a first direction of the heel loop and/or the vertical support member; and
a second bumper component mounted on said second bumper support, said second bumper component being operative to limit the movement in a second direction of the heel loop and/or the vertical support member.

67. (canceled)

75.-77. (canceled)

78. A combination comprising:
a sports article; and
the interface system of claim 62.

79. A combination comprising:
a sports article;
a boot; and
the interface system of claim 62.

80.-86. (canceled)

87. An interface system for retaining a foot or boot of a user on a sports article, the interface system comprising:
a base structure consisting of a first edge having a first back portion and a first front portion and a second edge having a second back portion and a second front portion, and a heel loop portion that is either connected to said first edge and to said second edge, or is integral with said first edge and said second edge;
a means for linking the first edge and the second edge that is operative to secure the foot or boot in the interface system;
said system further comprising: a vertical support member that is attached to the heel loop or base portion; wherein the vertical support member compromises:
a first layer that is closest to the users foot and a second layer, the first layer being pliable and capable of forming a pocket in the Achilles tendon area of the users foot and the second layer being rigid or semi-rigid, said first layer being constructed and proportioned so as to form a gap between itself and said second layer thus, allowing said first layer to dynamically form said pocket in the presence of the users foot or boot.

88. The interface system of claim 87 wherein an intermediate layer is introduced between the first and second layers, said intermediate layer compromises:
a curved semi-rigid element of similar shape to the first and second layers, constructed and positioned so as to broaden the support of the first layer and to improve said gap between the first and second layers.

89. The interface system of claim 62 further compromising;
a minimum of one linkage length adjustment element such as a winding knob or ratcheting lever, said adjustment element or elements intersecting one or many of said linkage members.
